(19) United States
(12) Patent Application Publication
(10) Pub. No.: US 2016/0335698 A1
(43) Pub. Date: Nov. 17, 2016

(54) SYSTEMS AND METHODS FOR EVALUATING AND PURCHASING EFFICIENT LIGHTING

(71) Applicant: SocketFlip, Inc., Orinda, CA (US)

(72) Inventors: Matthew Jones, San Francisco, CA (US); David Dreesen, Orinda, CA (US)

(21) Appl. No.: 15/154,904

(22) Filed: May 13, 2016

Related U.S. Application Data
(60) Provisional application No. 62/162,589, filed on May 15, 2015.

(51) Int. Cl. G06Q 30/06; G06Q 30/02

(52) U.S. Cl. CPC G06Q 30/0629; G06Q 30/0201; G06Q 30/0631; G06Q 50/06

(57) ABSTRACT

Systems and methods for inventorying existing products, evaluating the financial, convenience, and environmental impact of installing replacement more energy efficient products, purchasing energy efficient products, and/or assessing actual savings are described. Embodiments of the system are designed to allow a user to provide known and/or easily available information to quickly assess the attractiveness of changing to energy efficient products, prioritize potential purchases, buy or lease products, and assess actual and/or estimated savings, if desired. Some embodiments include a product database having entries identifying information about lighting products, an efficiency application causing a computing device to collect lighting product information currently in use by a user via one or more graphical user interfaces, and an efficiency platform connected to computing devices executing the efficiency application. The efficient platform can, among other things, develop a replacement recommendation by identifying more efficient alternatives for each of the user's identified lighting products.

### CROSS-REFERENCE TO RELATED APPLICATIONS

This application claims priority to U.S. Provisional Application Ser. No. 62/162,589, filed May 15, 2015, which is incorporated herein by reference in its entirety for all purposes.

### TECHNICAL FIELD

Various embodiments of the present technology generally relate to the assessment of the benefits and cost of installing energy efficient lighting products and the procurement of these products. Some other embodiments of the technology can be used for other energy savings devices such as but not limited to solar energy systems, appliances, windows, and/or the like. Embodiments of the systems and methods can apply to multiple types of electricity users including users in residential, commercial, and/or public-sector facilities.

### BACKGROUND

The field of evaluating and purchasing energy efficient products is very large and diverse. Manufacturers of energy efficiency products promote their product's energy and cost saving advantages. Electric utilities provide numerous programs for electricity consumers to install more energy efficient products. There are many established energy services companies that work with energy users to provide cost-effective energy efficiency retrofits across a wide spectrum of facilities.

Incandescent light bulbs (or lamps) are widely used in household and commercial lighting. They generally have a low manufacturing cost but are inefficient with typically less than 5% of the energy they use converted into visible light. Incandescent bulbs typically have very good dimming capability and turn on instantly.

A fluorescent lamp is typically a tubular lamp that converts electrical energy into useful light much more efficiently than incandescent lamps. Fluorescent lamp fixtures are usually more costly than incandescent lamps because they require a ballast to regulate the current through the lamp. However, the lower energy cost can offset the higher initial cost. This has made fluorescent lamps a common choice for commercial buildings where lights are on much of the day.

Compact fluorescent lamps (CFLs) are a type of fluorescent lamp that includes the ballast as part of the lamp and can be used as a direct replacement of incandescent bulbs in most popular applications. They are typically more costly than incandescent bulbs, but CFLs' high efficiency makes them a good energy-saving alternative. However, even though CFLs have been available for many years, CFLs have had only a modest market penetration. Complaints include poor dimming, slow start time, shorter life than expected, undesired light color, and flicker. Additionally, because they contain mercury, many fluorescent lamps are classified as hazardous waste. The United States Environmental Protection Agency recommends that fluorescent lamps be segregated from general waste for recycling or safe disposal.

An LED bulb is a light-emitting diode (LED) product that is assembled into a bulb (i.e., lamp) for use in lighting fixtures. LED bulbs have emerged over the last several years as a great energy saving alternative. Today's LED bulbs are more energy efficient than conventional incandescent lights typically cutting energy use by approximately 80 percent and often lasting more than 25 times longer, providing customers the convenience of a reduction in number of bulbs having to be purchased and installed. However, LEDs are typically more costly to purchase. LED lamp efficiency and lifetime is also significantly better than most fluorescent lamps with improved start time and dimmability. LED bulbs are not classified as hazardous waste. LED bulb manufacturers continue to make improvements to both the quality of light, brightness, dimmability, and the energy efficiency of LEDs while cutting their costs. Additionally, organic light-emitting diode (OLED) lighting products are now available in some applications and other forms of solid state lighting are being developed.

The advantages of LED bulbs have led to meaningful deployment in the past few years in both commercial and residential applications. There are numerous manufacturers of LED bulbs covering popular bulb types and light output. The LED bulb market is forecasted to grow in excess of 20% annually for several years. However, the market growth has been hampered by the complexity of the purchase decision for consumers.

The decision to install LED lighting for a typical consumer has many elements that often make the decision process very complicated, especially when spending significantly more than for a traditional bulb. First, gathering the typical usage and existing bulb type can be cumbersome. Specifically, often there are many different light switches with different numbers and types of bulbs that are used for varying amounts of time. Second, there are many manufactures of bulbs with varying quality. Some bulbs are excellent while others can buzz, flicker, and dim poorly. It is time consuming for a consumer to research and find the best bulbs for their purposes. Third, many bulbs can have several different specifications to select (e.g., color, beam angle, lumen output, fully enclosed fixture, dimmability, color rendering index, etc.). Fourth, bulbs are traditionally bought based on ‘Watts’ while LED bulbs are sometimes sold based on lumen output for which the consumer has limited knowledge. Still further, estimating the energy savings requires knowing the details of the consumer's rate structure from their electricity supplier and properly applying the energy savings from the LED bulbs to be installed.

Adding to the complexity, electricity pricing varies widely from country to country, and can vary significantly from locality to locality within a particular country. In standard regulated monopoly markets, electricity rates typically vary for residential, commercial, and industrial customers. Prices for any single class of electricity customer often do not utilize flat rate pricing, but rather a tiered pricing where the baseline allowance corresponds with the lowest rate per kWh and electricity rates rise progressively as electricity use reaches additional tiers. Rates also can vary by season. Further, prices can vary by time-of-day, by the capacity or nature of the supply circuit, or through real-time dynamic pricing where prices vary between times of low and high electricity network demand. Therefore, typically only average data are presented. For example, manufacturers often provide product labeling to help customers assess some benefits of LED bulbs. To show energy savings, product packaging often uses average electricity rates (e.g., 11 cents per kWh in the United States) with an estimated usage of typically 3 hours to provide an estimate of the annual savings and savings over the life of the LED bulb. Additionally, to highlight the long life of LED bulbs, packages often list the lifetime in hours (e.g., “25,000 hour lifespan”), in years based on typical usage (e.g., “Life=22.8 years”), or show a picture or text to articulate the equivalent number of incandescent or fluorescent bulbs (e.g., “1 LED bulb=5 CFLs”).

There is an emerging market to provide online tools to help consumers through the process of purchasing energy efficient products. Tools to assist with purchasing energy efficient products include:
Energy Audit Tools: Energy audit software has existed for many years. For example, home energy audit software allows a user to enter basic information about their location, structure, insulation, heating, cooling, appliances, and lighting. The home energy audit then can provide financial savings and environmental impact estimates from installing energy upgrades. Home energy audits can be useful, but have had limited success in the marketplace to date. They alert a user of potential savings based on high level estimates, but require additional steps to implement solutions. For example, energy audit software can collect the number of bulbs in a house that are incandescent and the number that are LEDs or CFLs or can ask generic question to determine the level of lighting (e.g., high number of lights, average, or low number of lights). With this information, the audit can estimate savings and refers the user to a retailer web site (e.g., homedepot.com) to buy bulbs.
LED Bulb Savings Calculators: There are online tools that are useful in helping a user assess the financial benefits of switching to LED bulbs (or CFLs). The most advanced tools allow a user to enter the number of bulbs of a given bulb type; provide information on the existing bulb including wattage, price, and lifespan; provide information on the replacement bulb including wattage, price, and lifespan; select an energy rate; provide hours of operation for the bulb; and labor cost of replacing bulbs. These tools then present results that can include initial bulb cost, total wattage for entered bulbs, electricity cost, lifespan in years, number of times a traditional bulb would be replaced, cost of bulb replacements, total annual cost, total cost over life of LED bulbs, total savings over life of LED, and break-even point for returning initial additional cost. While this level of detail is only available by assessing one bulb type at a time, there are manufacturers that provide simple summary level energy and environmental savings information for more than a single bulb type (e.g., one or more 60 watt A19 bulb and one or more 75 watt A19 bulb), by selecting the quantity of bulbs of each type. None of these tools are integrated into a bulb inventorying process or purchase process (other than some identifying retailers who carry bulbs), but rather are stand-alone tools.

Computers, smartphones (e.g., iPhones) and tablets (e.g., iPads) that are connected online are useful in allowing users to provide needed data, capture images, and/or take videos as well as provide users information to make decisions and complete transactions. Notably, the functionality and performance of these devices is rapidly improving and the market penetration of devices continues to grow. Use of these devices in the field of energy audit software to help obtain more detailed energy audit information with a simple process has been advancing. Techniques for obtaining energy audit information from images captured from mobile computing devices are described in U.S. Pat. No. 8,805,000 entitled “Mobile energy audit system and method” and are also described in US Patent Application No 2013/0262040 A1 “Systems and Methods for home energy auditing”.

Historically, consumers have been slow to adopt energy efficiency lighting. Typically, saving money on electricity is a low priority for most consumers. Hence, while there is interest in the financial, convenience, and environment benefits of more-efficient and longer-lived products, the effort associated with assessing the cost/benefit and then making the change creates a major barrier for adoption. Support from government entities has helped make decisions for consumers easier (e.g., Energy Star) and legislation and building codes has helped force adoption. Tools to help guide the consumer have improved. However, to drive large-scale adoption, what is needed is a comprehensive solution that simply guides a consumer through the full process and gives straight-forward advice from a trusted source.

### SUMMARY

Various embodiments of the present technology use systems and methods to enable a user of the system to capture information on an existing inventory of light bulbs, assess the financial, convenience, and/or environmental impact of buying more energy efficient light bulbs, and/or to purchase light bulbs.

The present technology has several advantages over existing systems. While some systems incorporate some aspects, both the combination and many of the systems and methods of implementation of the present technology are unique:
Comprehensive System: Some embodiments provide for a comprehensive system that allows users to inventory bulbs and prioritize the replacement of bulbs based on financial, convenience, and/or environmental criteria. Users can then select which bulbs to replace with more energy efficient alternatives, customize bulb features, and purchase.
User Specific Usage and Rates: Some embodiments can use minimal information from the user to calculate the customized expected monetary savings achieved through installing more efficient bulbs. For example, a single typical monthly electricity bill and location information (e.g., zip code) can be used to obtain required data to estimate the user's actual electricity rate(s) to apply to the reduced electricity usage from more efficient bulbs. If the monthly electricity bill is not known, the user can enter basic known information about the building and the system calculates an estimated monthly bill based on typical usage from similar buildings. Some embodiments allow users to optionally provide detailed actual electricity data for use in calculations (e.g., monthly bills, monthly kWh usage, and/or hourly kWh for several months, a year, or longer).
Customized Savings using User Specific Rates and Usage: Some embodiments of the system can calculate the total electricity usage before and after changing selected bulbs for desired time periods (e.g., month, year). Where a user has a tiered rate structure and lower usage results in moving from one pricing tier into one or more different pricing tiers, the system applies the correct rate based on usage within the associated pricing tier. The system also can calculate savings from demand charges and other charges, as applicable.
Streamlined Bulb Inventory System: Some embodiments allow users to inventory existing bulbs by gathering required information through an easy to use graphical user interface. Information gathered can include the room, the bulb type, a location description, number of bulbs, bulb watts, bulb technology type (e.g., incandescent), and how many hours the bulbs are used within a given time period. For example, various embodiments can:
   Allow bulb information to be entered by the switch that controls the given bulb(s) allowing hours per bulb to be easily estimated by the user, by the type of bulb used across multiple switches if the hours used are consistent across those switches, or a combination of the two.
   Optionally, allow the user to create a floor plan and drag and drop lights and switches. Once created, it can allow users to access remotely controlled light switches directly from the floor plan interface. In one embodiment, it allows the floor plan to be created from walk through video or images of the premises.
   Optionally, estimate lumens of a light bulb, either omni-directional or directional light, using the ambient light sensor on a smart phone or tablet.
   Optionally, allow data from camera images and/or videos simplify the bulb inventorying process.
      For an uninstalled bulb or highly visible installed bulb, it can determine the bulb type based on the dimensions of the bulbs and/or the connectors.
      For an installed bulb (e.g., recessed bulb), it can determine the bulb type or limit bulb type options from a camera image or video using an estimate of the distance of the camera from the bulb.
      It can estimate if a fixture is fully enclosed.
      It can stores images and videos for manual reference in the bulb matching process
Prioritized Bulb List and Bulb Replacement Selection: One or more embodiments can provide a prioritized list recommending the order in which bulbs should be replaced based on financial, convenience, and/or environmental criteria. For all bulbs or a desired subset of bulbs (e.g., high priority, user selected), it presents information to assist a user in selecting the bulbs to replace that includes estimated total savings, financial payback in years, number of bulb changes saved, investment return data, bulb replacement priority, estimated environmental benefits, and/or other summary data. For example, some embodiments can:
   Provide the estimated size and cost of a solar power system that would produce the same electricity as the more efficient bulbs would be expected to save.
   Use specifically matched bulbs for purchase for calculation of prioritization and savings. Where a bulb is not yet matched, the system can use representative typical replacement bulb data.
Automatically Identify Replacement Bulbs for Existing Bulbs: Some embodiments can automatically match bulbs entered by users to one or more available appropriate energy efficient replacement bulbs based on bulb type, wattage, light color, fixture color, whether fixture is fully enclosed, and/or whether the user would like more or less light than the existing bulb.
Unique Bulb Purchase Options: Some embodiments can provide unique bulb ordering and payment options to facilitate bulb procurement that can include:
   Allowing users to select bulbs for replacement and, if desired, split into two or more bundles where one or more bundle order is finalized in the future.
   Allowing for the user to pay for bulbs over time.
   Allowing user to rent the bulbs, where the monthly rental fee is less than money saved from the more efficient bulbs.
   Tracking the savings from a set of purchased bulbs and then buy additional bulbs based on the savings provided from the installed bulbs.
   Providing users the option of a small set of bulbs (e.g., starter package) that provides representative bulbs from the full desired set of bulbs.
Estimate Actual Savings: Some embodiments can estimate the actual savings generated by a user's installed bulbs using actual usage and/or billing data. In at least one embodiment, actual savings after installing bulbs can be compared with estimated savings prior to installing bulbs. Uniquely, the system matches detailed interval usage data by day of the week with representative same day of week usage data from prior to replacing bulbs.

While multiple embodiments are disclosed, still other embodiments of the present technology will become apparent to those skilled in the art from the following detailed description, which shows and describes illustrative embodiments of the invention. As will be realized, the present technology is capable of modifications in various aspects, all without departing from the scope of the present technology. As just one example, other embodiments of the present technology utilize the systems and methods for other or a combination of energy saving products (e.g., windows, electronic equipment, appliances, solar panels, etc.). Accordingly, the drawings and detailed description are to be regarded as illustrative in nature and not restrictive.

### BRIEF DESCRIPTION OF THE DRAWINGS

Embodiments of the present technology will be described and explained through the use of the accompanying drawings in which:

FIG. 1 illustrates an example of a networked-based environment in which some embodiments of the present technology can be utilized.

FIG. 2 illustrates an example of a high-level application process flow in accordance with some embodiments of the present technology.

FIG. 3 illustrates an example of a process flow for gathering or estimating the user electricity usage and rates in accordance with one or more embodiments of the present technology.

FIG. 4 illustrates an example of a process flow for gathering or estimating existing product information in accordance with various embodiments of the present technology.

FIG. 5 illustrates an example of a process flow for estimating the financial, convenience, and/or environmental impact with energy efficient products in accordance with some embodiments of the present technology.

FIG. 6 illustrates an example of a process flow for selecting products for purchase using prioritized financial, convenience, and environmental impact data in accordance with one or more embodiments of the present technology.

FIG. 7 illustrates an example of a process flow for purchasing or leasing desired products in accordance with various embodiments of the present technology.

FIG. 8 illustrates an example of a process flow for calculating and/or measuring estimated savings in accordance with various embodiments of the present technology.

FIG. 9 illustrates an example of a diagram of an example comparison of interval usage data before and after changing bulbs.

FIGS. 10-36 are example screenshots of graphical user interfaces that can be used in accordance with some embodiments of the present technology.

FIG. 37 is a block diagram illustrating an example machine representing the computer systemization of the efficiency system.

The drawings have not necessarily been drawn to scale. Similarly, some components and/or operations can be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described.

### DETAILED DESCRIPTION

Systems and methods for inventorying existing products, evaluating the financial, convenience, and environmental impact of installing replacement more energy efficient products, purchasing energy efficient products, and/or assessing actual savings are described. Embodiments of the system are designed to allow a user to provide known and/or easily available information to quickly assess the attractiveness of changing to energy efficient products, prioritize potential purchases, buy or lease products, and assess actual and/or estimated savings, if desired.

Various embodiments of the present technology provide for a variety of technological advances in a variety of technical fields. For example, in the energy audit field, some of the technological advancement include, but are not limited to the following: 1) integration and implementation of customized, actionable advice based on a review of the user's energy situation; 2) implementation of a comprehensive process from assessment through purchase (and installation, if desired) that eliminates the need for additional actions for the user to complete energy upgrades; 3) implementation of improved customized savings calculations to improve accuracy of savings estimates; 4) customized reviews of the user's energy situation and recommendations for meeting desired goals and priorities; 5) implementation of a mechanism for accurately and efficiently inventorying existing light bulbs and usage information by room and/or by switch; and 6) other mechanisms for creating actionable plans that the user is likely to have success implementing.

In the following description, for the purposes of explanation, numerous specific details are set forth in order to provide a thorough understanding of embodiments of the present technology. It will be apparent, however, to one skilled in the art that embodiments of the present technology can be practiced without some of these specific details.

Moreover, the techniques introduced here can be embodied as special-purpose hardware (e.g., circuitry), as programmable circuitry appropriately programmed with software and/or firmware, or as a combination of special-purpose and programmable circuitry. Hence, embodiments can include a machine-readable medium having stored thereon instructions that can be used to program a computer (or other electronic devices) to perform a process. The machine-readable medium can include, but is not limited to, floppy diskettes, optical discs, compact disc read-only memories (CD-ROMs), magneto-optical discs, ROMs, random access memories (RAMs), erasable programmable read-only memories (EPROMs), electrically erasable programmable read-only memories (EEPROMs), application-specific integrated circuits (ASICs), magnetic or optical cards, flash memory, or other type of media/machine-readable medium suitable for storing electronic instructions.

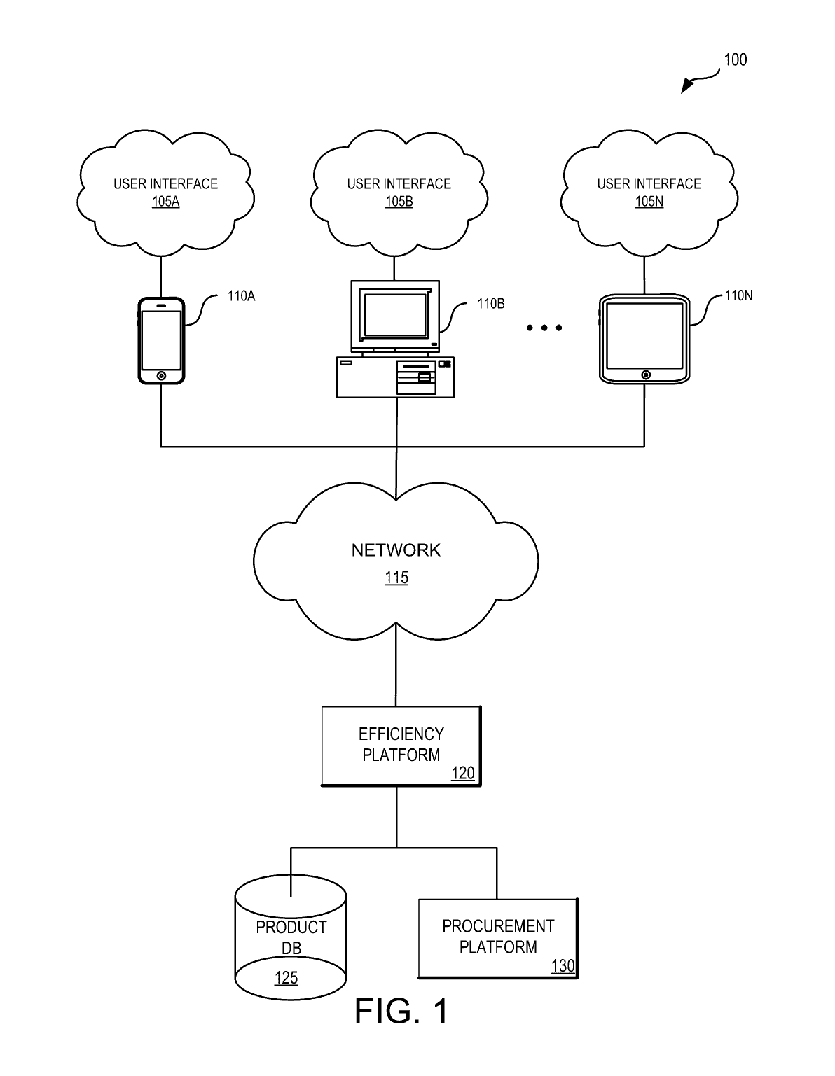

FIG. 1 illustrates an example of a network-based environment 100 in which some embodiments of the present technology can be utilized. The embodiments illustrated in FIG. 1 show computing devices 110A-110N that can be any suitable computing device capable of receiving user input as well as transmitting and/or receiving data via the network 115. In one embodiment, the computing devices 110A-110N can be a conventional computer system (e.g., a desktop or laptop computer) or a mobile device having computer functionality (e.g., a mobile telephone, a smartphone, wearable computer, etc.). The computing devices 110A-110N can be configured to communicate with an efficiency platform 120 via network 115. In some embodiments, the computing devices 110A-110N can retrieve or submit information to the efficiency platform 120 and run one or more applications for evaluating the benefits and cost of installing energy efficient lighting products and the procurement of these products, generating one or more recommendations based on environmental and/or budgetary constraints, creating an actionable plan, evaluating actual costs savings, and providing reminders to assist the user in meeting future goals.

In accordance with various embodiments, the efficiency platform 120 can communicate with a product database 125 to retrieve data from one or more products, request quotes, and/or retrieve or request other types of information. The product database 125 can include various database components that can be implemented in the form of a database that is relational, sequential, hierarchical, scalable, and/or secure. Examples of such database include DB2, MySQL, Oracle, Sybase, and the like. Alternatively, these databases can be implemented using various standard data-structures, such as an array, hash, list, struct, structured text file (e.g., XML), table, and/or the like. Such data structures can be stored in memory and/or in structured files.

The computing devices 110A-110N can execute a browser application or a customized client to enable interaction between the computing devices 110A-110N and efficiency platform 120. In addition, the efficiency platform 120 can be able to directly access or receive instructions or information from various systems of a procurement platform 130. For example, the procurement platform 130 can have multiple systems such as transactional system, product acquisition system, automatic payment systems, etc. which are communicably coupled to the efficiency platform 120. These systems can be utilized by the efficiency platform in creating recommendations and executing the recommendations by placing orders for desired products.

The network 115 can include any combination of local area and/or wide area networks, using both wired and wireless communication systems. In one embodiment, the network 115 uses standard communications technologies and/or protocols. Thus, the network 115 can include links using technologies such as Ethernet, 802.11, worldwide interoperability for microwave access (WiMAX), 3G, 4G, CDMA, digital subscriber line (DSL), etc. Similarly, the networking protocols used on the network 115 can include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over the network 115 can be represented using technologies and/or formats including hypertext markup language (HTML) or extensible markup language (XML). In addition, all or some links can be encrypted using conventional encryption technologies such as secure sockets layer (SSL), transport layer security (TLS), and Internet Protocol security (IPsec).

In some embodiments, the efficiency platform 120 includes various data processing and analytic tools that allow for implementation, creation, and evaluation of customer objectives relating to the customer's personalized situation and efficiency savings goals. The efficiency platform 120 can be implemented in distributed computing environments, where tasks or modules are performed by remote processing devices, which are linked through the network 115. In a distributed computing environment, program modules or subroutines can be located in both local and remote memory storage devices. Distributed computing can be employed to load balance and/or aggregate resources for processing.

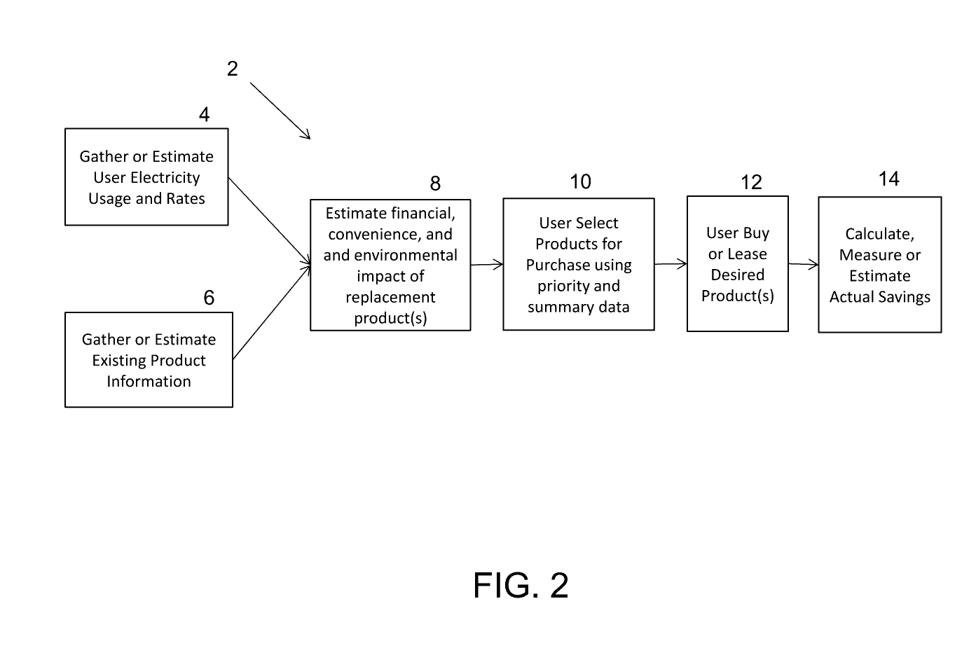

FIG. 2 provides an overview of a process in accordance with various embodiments of the present technology for the analysis and procurement of energy efficient light bulbs. The process 2 illustrated in FIG. 2 commences with gathering or estimating the user's typical electricity usage and rates from known information for the user such as zip code and typical monthly bill amount (4). The system then gathers information to obtain the number and types of light bulbs, as well as typical usage over a day, or other desired time period (6). Using a user's utility rates, existing bulb data, and data for energy efficient bulbs, the system calculates the change in user's electricity usage and financial, convenience, and environmental impact are calculated for one, all, or some bulbs (8). The system provides financial, convenience, and/or environmental impact data to help the user prioritize bulb purchases and select the bulbs to be replaced (10). The system then provides one or more purchase or lease options that can include purchasing bulbs with energy savings (12). After installing bulbs, the system can use actual data from a user to calculate, measure, or estimate the actual realized savings from the replacement bulbs (12).

### 1. Gather or Estimate User Electricity Usage and Rates

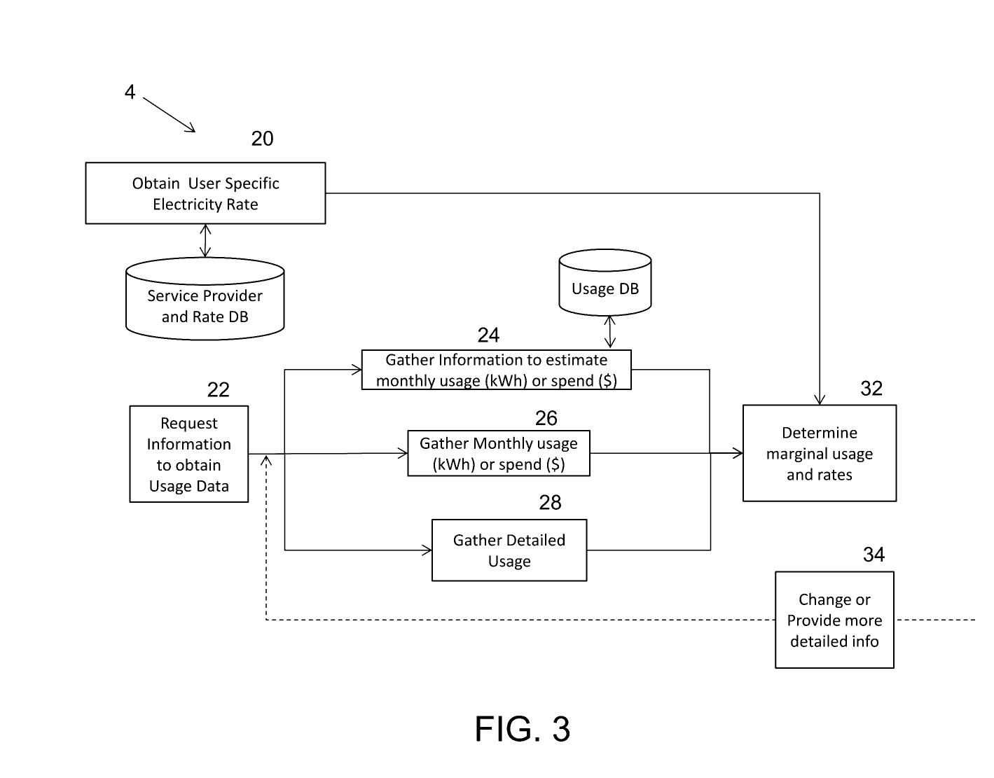

FIG. 3 shows a process 4 for obtaining or estimating user electricity usage and rates in accordance with an embodiment of the present technology.

Obtain User Specific Electricity Rate:

The process illustrated in FIG. 3 commences by the user entering location information for the premises such as zip code, area code, or address (20). Alternatively, location based services from a GPS or other method can be used. With this location, the system accesses data to identify electricity service provider (ESP) for the premises. In some cases, there can be one of multiple service providers servicing the location. Therefore, the user can be requested to specify their ESP, if rate differences are determined to provide a meaningful difference. Alternatively, instead of using location information, the user can enter or select their electricity service provide directly, if known. The system obtains the rate structure specifically for the user based on information provided.

As an example, the user enters a zip code 12345 for a residential premises, the system determines that the ESP for that zip code is XYZ Energy. The system looks up the rate structure and determines that the ESP charges customers a tier 1 rate of $0.10/kWh for all kWh used up to 300 kWh and a tier 2 rate of $0.20/kWh for all kWh used after 300 kWh in a billing period.

Obtain Usage Information:

Next, the system requests users to provide a monthly electricity bill, information to allow the system to estimate the monthly bill (or usage can be estimated directly based on similar properties), or provides access to their account with their ESP so that actual usage data can be used by the system (22). The user then provide one or more of the following:
Information to Estimate Monthly Usage: The user enters information to estimate the bill. For example, a residential user could enter information such as the size of their home, number of people, and an estimate of whether they are a low, medium, or high electricity user. The system then estimates their monthly bill or usage by using standard comparison methodologies, such as linear regression, or direct comparison to similar homes (24).
Monthly Bill or Monthly Usage: The user enters an actual or estimated monthly billing amount and/or kWh usage (26).
Access to ESP Billing Data: The user provides access to their detailed bill and/or usage data from their ESP. For example, by providing login information, data can be accessed directly and uploaded. Alternatively, some ESPs provide direct access to data where a third party is approved by a customer (28).

Determine Usage and Marginal Rate for Energy Savings:

The system then uses user billing data and or usage data with the rate structure for the user's ESP to determine the usage and associated rates that would be impacted by installing energy efficient bulbs (32).

For a typical billing rate, usage can be calculated from billing date with the following formulas:

$$For i = 1 to n \text{:}$$

$$Remaining {Bill}_{i} = Total Bill - {\sum }_{i = 2}^{n} ( {Tier}_{i - 1} Usage \times {Tier}_{i - 1} Rate )$$

$${Tier}_{i} Usage = min ( \frac{Remaining {Bill}_{i}}{{Tier}_{i} rate} , Tier Baseline Usage )$$

$$Total Usage = {\sum }_{i = 1}^{n} {Tier}_{i} Usage$$

### Where:

n=number of tiers
Tier Usage=the electricity usage (e.g., kWh) within a given tier
Total Usage=the total electricity usage (e.g., kWh) for the period
Total Bill=the total bill for the specified time period.
Remaining Bill=the amount of the Total Bill remaining after deducting amounts applied to previous tiers.
Tier Baseline Usage=maximum usage allowed in a pricing tier (infinite for final tier)
Tier rate=billing rate for the associated tier
   Using the aforementioned example, if the user enters $34 as their monthly bill, the system calculates a monthly usage of 320 kWh based on 300 kWh at $0.10/kWh and 20 kWh at $0.20/kWh as follows:
Remaining Bill₁=$34
Tier₁ Usage=min ($34/$0.10/kWh, 300 kWh)=300 kWh
Remaining Bill₂=$34−(300 kWh×$0.10/kWh)=$4
Tier₂ Usage=min ($4/$0.20/kWh, infinity)=20 kWh
Total Usage=300 kWh+20 kWh=320 kWh
   In accordance with various embodiments, the formula can be adjusted to account for other charges to match the user's ESP rate structure. For example, if a fixed charge exists (e.g., $10 per month plus usage fees), the fixed charge would be subtracted from the Total Bill prior to calculating the usage.

At points later in the process, the user can provide updated or more detailed billing or usage information (34) to improve the accuracy of the savings calculation.

In other embodiments, the system operates on monthly billing data without the use of detailed actual usage data directly from their ESP, or is only prompted to provide access to this data if the system determines that the user can find this more detailed data beneficial to the user's purchase decision.

In another embodiment, the system obtains actual submeter data specifically for a single bulb or multiple sets of bulbs connected to a switch or other sensor that tracks the actual usage for than specific bulb or set of bulbs.

### 2. Gather or Estimate Existing Product Information

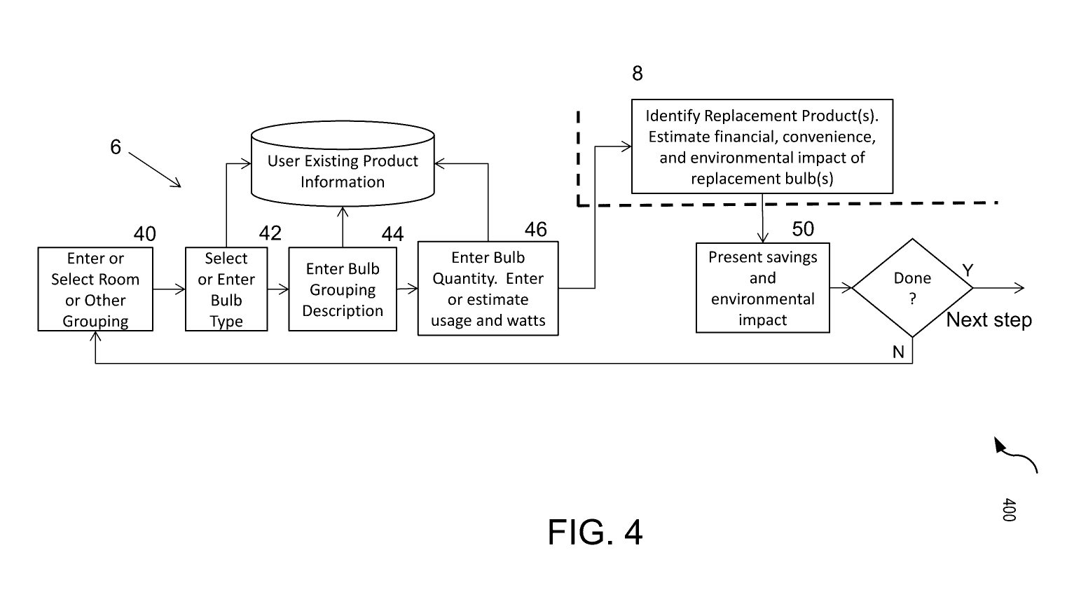

A process 6 for capturing existing product data from a user in accordance with an embodiment of the present technology is illustrated in FIG. 4. In one configuration, a user selects or enters a room location (or other description if bulbs are across multiple rooms) for a set of bulbs through a graphical user interface (40). The user then selects or enters the bulb type for the bulbs. This can include details of the bulb shape, connectors, and/or whether clear or frosted (42). The system can allow users to inventory bulbs by the switch that controls them. This simplifies the inventorying process since the time that a bulb is used impacts the savings and bulb usage often varies by switch. However, where the same type of bulb is used for a similar number of hours, the user can group these bulbs for entry across multiple switches or rooms. To support bulb groupings, the system allows the entry of a bulb grouping description (e.g., kitchen island, family room recessed) where the previously entered information does not adequately identify the bulbs (44).

The user then enters the quantity of bulbs, estimated usage (e.g., hours per day), watt rating of the bulb, if available, whether there is a dimmer, and/or the current bulb technology (46). The system stores existing bulb information. The system can then use process 8 to identify replacement bulbs/representative replacement bulb data, estimate financial, convenience, and environmental impact of the replacement bulbs and present results to the user (50). The user then repeats for all desired bulbs.

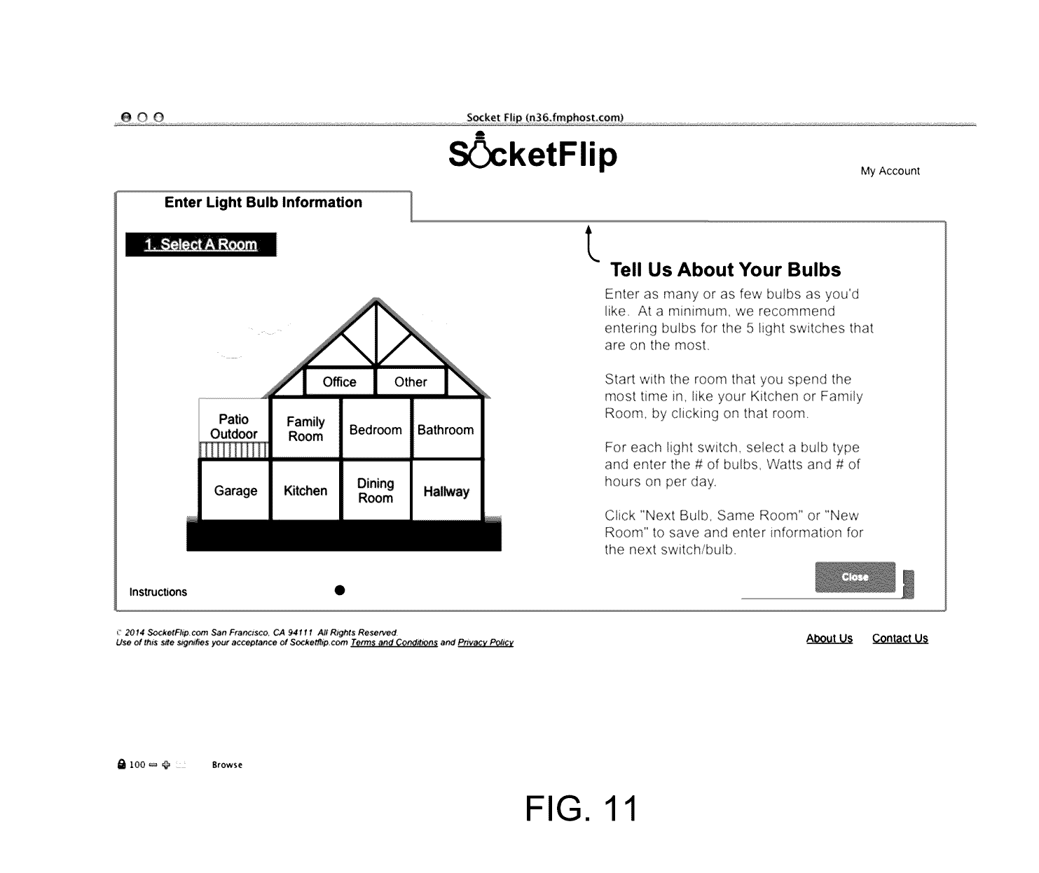

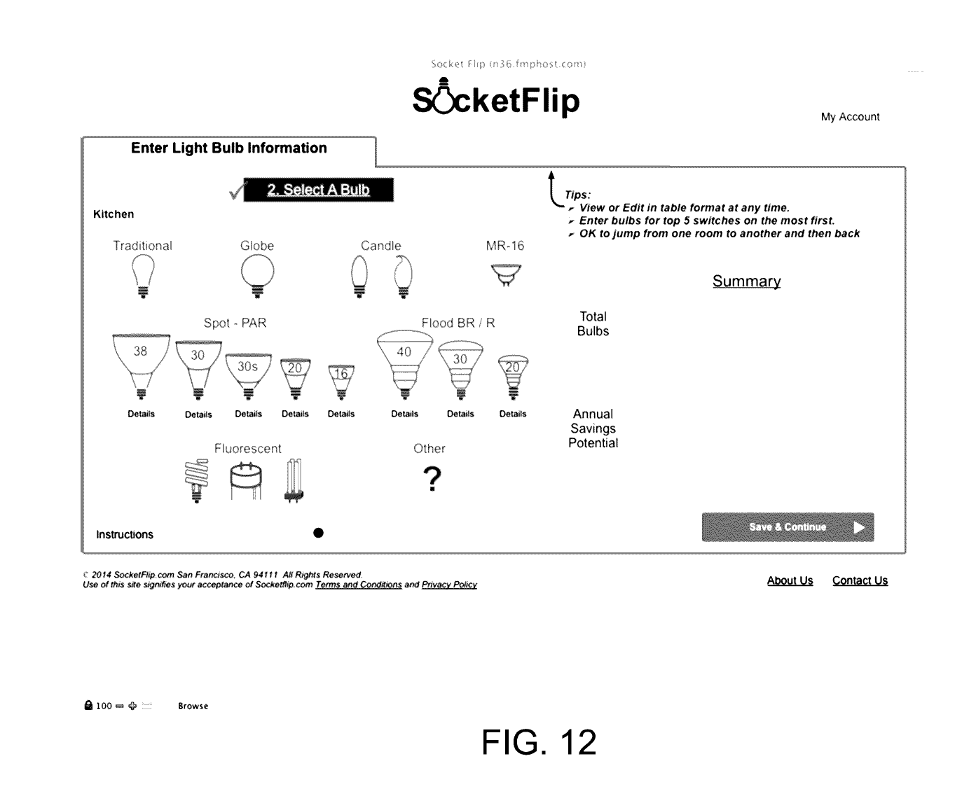

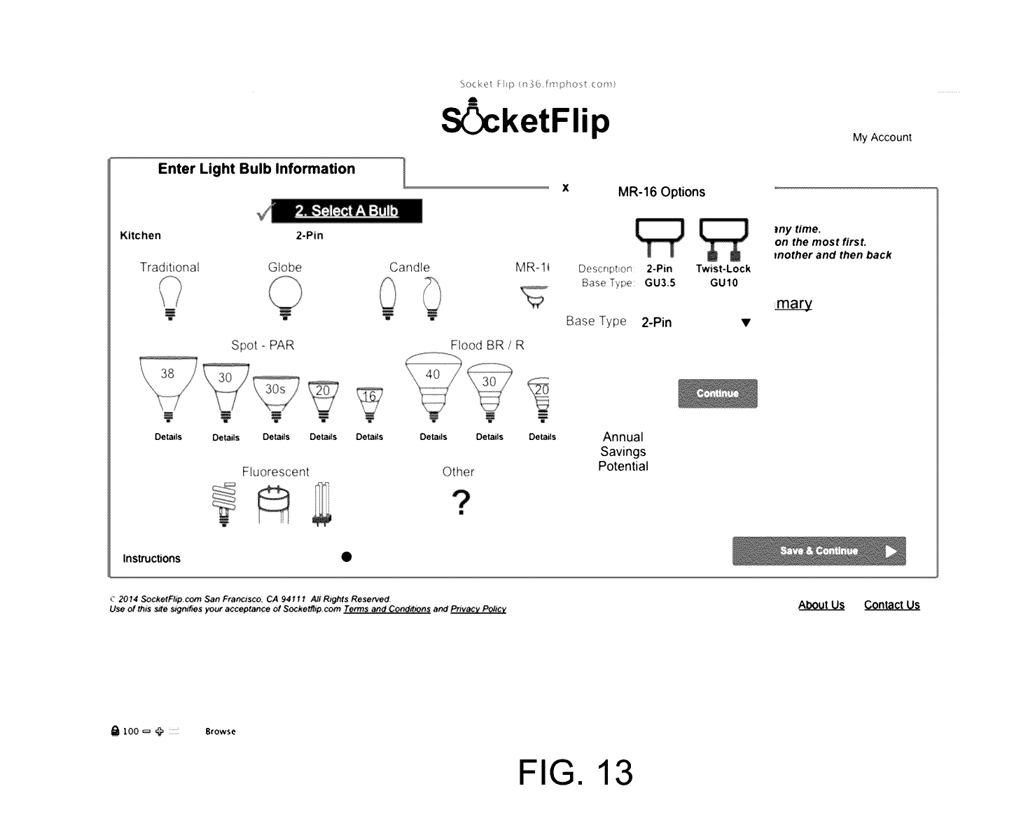

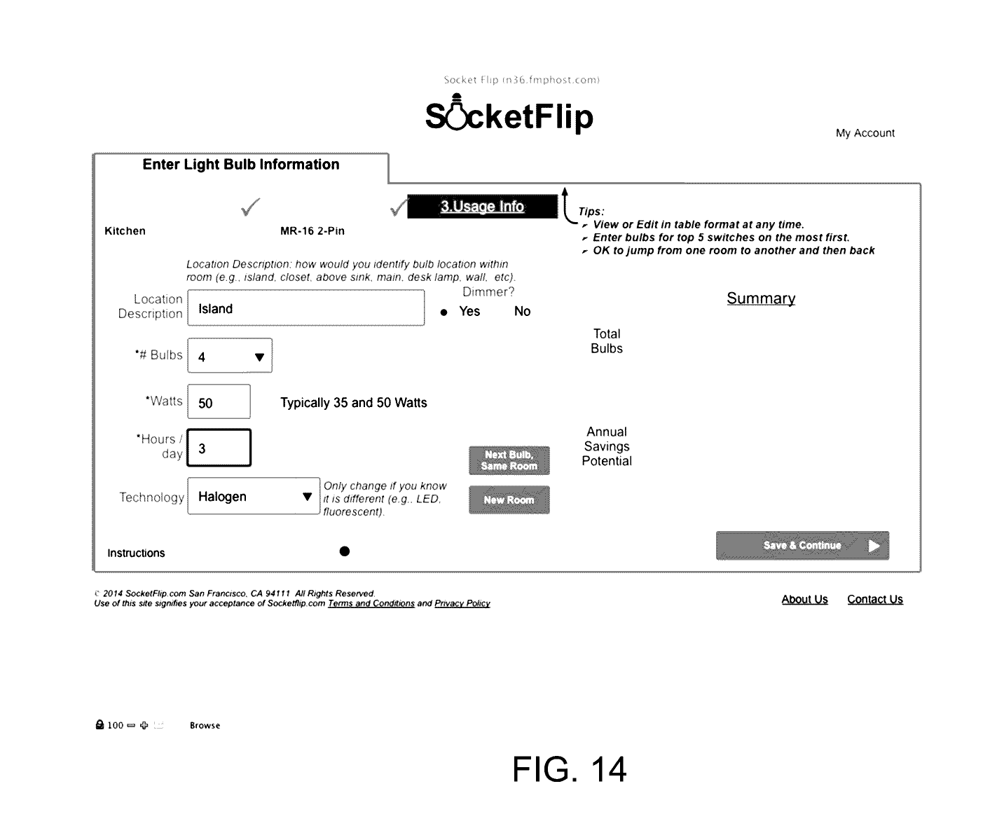

Continuing on the aforementioned example, the user has two switches where the user would like to consider LED bulb replacements. A user clicks on a graphic user interface (see, e.g., FIG. 11) to select the kitchen as the location of a set of bulbs. The user identifies the bulbs as MR-16 bulbs using the help of information provided by the system (see, e.g., FIGS. 12-13, enters a more detailed location description of “island” (see, e.g., FIG. 14), the number of bulbs as 6, watt rating of existing bulbs as 50 watts, the operating hours of 4 hours per day and the existing technology as the default for that bulb type as “halogen.” The user then selects to enter another switch following the same flow for ten 60 watt incandescent A19 bulbs for the main living room switch that the user estimates to be used 1 hour per day.

In another embodiment, the user uses a camera from a smartphone or tablet to identify the bulb type automatically. In the case where the bulb is not installed, during the bulb entry process, the user provides a photo or scan of the bulb. The shape of the bulb is compared with known dimensions of standard bulb sizes to identify the type of bulb. Where a bulb is installed (e.g., in a recessed can), a photo or scan of the image is used to identify the bulb type using estimates and/or input from the user of the distance of the camera from an object or object features such as the number of reflective elements across the face of the glass in a recessed bulb (e.g., par 30 having 39 rows of small reflective elements versus smaller par 20 have 24 rows). These dimensions, along with appearance of the bulb, allow the system to distinguish the bulb type automatically, and/or provide this image for manual processing. In some cases, the bulb type may not be fully determined, but the system can limit the number of options.

In another embodiment, the user takes pictures of installed bulbs and/or switches during the bulb inventorying process to assist in automatically and/or manually identifying the best replacement bulbs. Images can also be used identify not only the bulb type, but also bulb features such as shape, whether clear or frosted, whether appearance of the bulb is important, most appropriate color of visible base (e.g., decorative candelabra application), and whether the bulb is in a fully enclosed fixture.

In another embodiment, the user creates a floor plan for the premises from standard methods used in design, such as those in home design software. Alternatively, the floor plan can be derived automatically from video or images of the premises. The user then drags and drop lights and switches onto the floor plan. The user then enters relevant bulb data with the floor plan as the guide for inventorying bulbs. An additional benefit of the floor plan based entry is that once created, it provides the user an easy interface to manage control or scheduling of these devices. For example, a user could tap or click a set of bulbs then select a calendar to program the connected switch controlling the bulbs (or bulbs directly if connected bulbs) to automatically turn on and off as desired.

In another embodiment, the estimated lumens of a light bulb, either omni-directional or directional light, is obtained using the ambient light sensor on a smart phone or tablet.

3. Estimate Financial, Convenience, and Environmental Impact with Energy Efficient Products

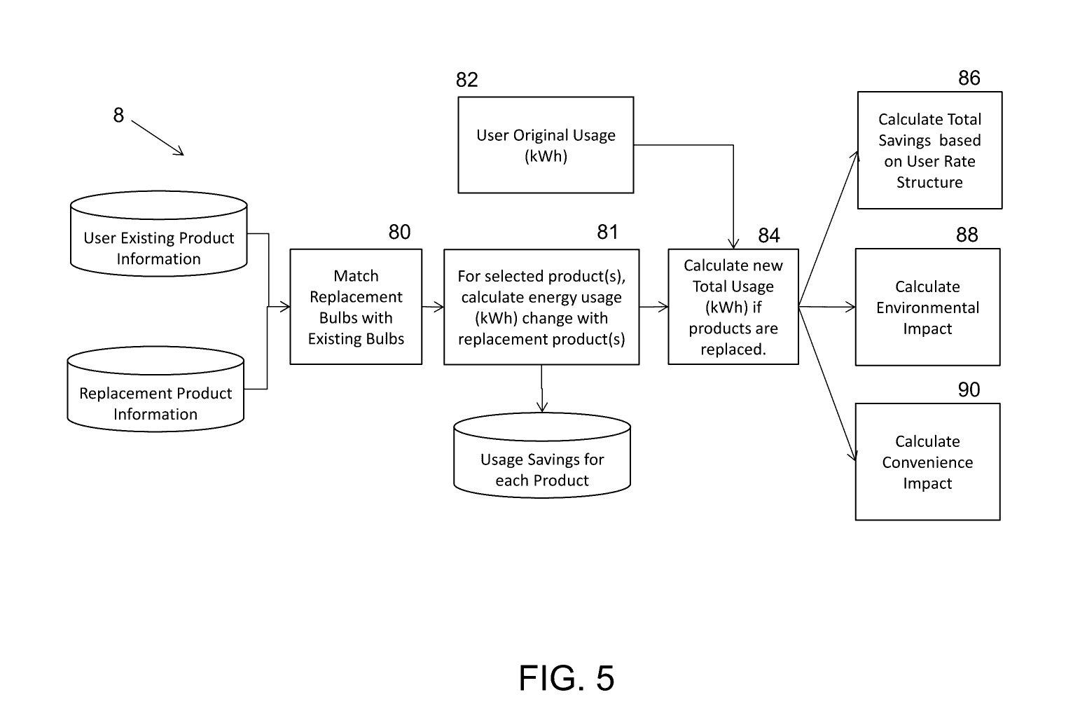

A process 8 for estimating the financial, convenience, and environmental impact of replacing bulbs with energy efficient bulbs in accordance with an embodiment of the present technology is illustrated in FIG. 5. The system can calculate the financial, convenience (due to longer life of bulbs requiring fewer changes), and/or environmental impact automatically for any number of the entered groupings of bulbs to assist in the bulb purchase process. The process begins with the system matching existing bulbs with replacement bulb data. Replacement bulb data can be exact bulb matches (e.g., prior to purchase), representative replacement bulbs data (e.g., for estimates prior to the system identifying the exact replacement match), or a mixture of both (80). Next, the system calculates the energy usage change for a predetermined or user selected set of bulbs using the watt rating for the current and replacement bulb and number of hours used in a time period (81). Using the user original usage (82) from process 4 and the change in usage, the system calculates the new total usage with the selected replacement bulbs (84). The system then applies the new usage to the user's specific rate structure to calculate the savings (86). Based on the usage savings, the system can also calculate the environmental impact from the reduced electricity usage (88) and the convenience impact of not having to change bulbs as frequently (90).

Where the system calculates an expected change in utility rate for a selected set of bulbs, some embodiments of the system can dynamically calculate and present the average savings for a selected set of bulbs.

First, the usage savings can be calculated for individual groupings of bulbs with the following formula:

$$U sage Savings {( kWh )}_{i} = \frac{\# {bulbs}_{i} \times hours \text{/} {day}_{i} \times {( {watt}_{existing} - {watt}_{new} )}_{i} }{1000} \begin{matrix}\times days \\ \end{matrix}$$

$$And the total usage savings by \text{:}$$

$$Total Usage Savings ( kWh ) = {\sum }_{i = 1}^{n} ( \frac{\# {bulbs}_{i} \times hours \text{/} {day}_{i} \times {( {watt}_{existing} - {watt}_{new} )}_{i}}{1000} \begin{matrix}\times days \\ \end{matrix} )$$

### Where:

i equals 1 to n, where n=number of bulb groupings entered
Usage Savings=electricity change in kWh
#bulbs=number of bulbs for each grouping
hours/day=hours per day that bulbs are on for each grouping
watt_{existing}=watt rating for existing bulb
watt_{new}=watt rating for replacement bulb
days=days in the specified period
   In other embodiments, the system can obtain actual or estimated usage (hours per day) for a given time of year (e.g., April). Since the amount of usage often can vary based on the number of daylight hours (e.g. shorter days in winter lead to more light usage), the system can adjust the estimated hours for the entire year based on typical usage patterns for similar premises.

In the aforementioned scenario, for a 30 day billing period, the user selects to evaluate replacing bulbs for the kitchen island and living room main switches. The system matches the 6 halogen 50 watt MR-16 bulbs with 10 watt LED replacements that cost $15 per bulb and the ten 60 watt incandescent bulbs with 10 watt LED replacements that cost $10 per bulb. Usage Savings for the 30 day period is then equal to:
Usage Savings₁=(6 bulbs×4 hours/day×(50 watts−10 watts)×30 days)/1000=28.8 kWh
Usage Savings₂=(10 bulbs×1 hours/day×(60 watts−10 watts)×30 days)/1000=15 kWh
Total Usage Savings=28.8+15=43.8 kWh
   Next, the system then can calculate the new usage as:

New Total Usage=Total Usage−Total Usage Savings

In, this case, New Total Usage equals 320 kWh−43.8 kWh=276.2 kWh.
Next, the system can calculate the Total Bill based on the new Total Usage using the following formulas:

$$For i = 1 to n \text{:}$$

$$Remaining {Usage}_{i} = Total Usage - {\sum }_{i = 2}^{n} {Tier}_{i - 1} Usage$$

$${Tier}_{i} Usage = min ( Remaining {Usage}_{i} , Tier Baseline Usage )$$

$${Tier}_{i} Bill = {Tier}_{i} Usage \times {Tier}_{i} Rate$$

$$Total Bill = {\sum }_{i = 1}^{n} {Tier}_{i} Bill$$

### Where:

n=number of tiers
Total Usage=total usage (e.g., kWh) for the period (or New Total Usage, as applicable)
Remaining Usage=the amount usage remaining after deducting amounts applied to previous tiers.
Tier Usage=amount of usage applied to a previous tier.
Tier Baseline Usage=maximum usage allowed in a pricing tier
Tier Bill=monetary amount of charges in a given tier
Tier Rate=ESP billing rate for a specified tier
Total Bill=monetary value of bill based on usage
   In the above example, the system can calculate the Total Bill for the new usage of 276.2 kWh:
Remaining usage₁=276.2 kWh−N/A=276.2 kWh
Tier₁ Usage=min (276.2 kWh, 300 kWh)=276.2 kWh
Tier₁ Bill=276.2 kWh×$0.10/kWh=$27.62
Remaining usage2=276.2 kWh−276.2 kWh=0 kWh
Tier₂ Usage=min (0, infinity)=0 kWh
Tier₂ Bill=0 kWh×$0.20/kWh=$0
Total Bill=$27.62+$0=$27.62
   The Total Savings is can be calculated by:

Total Savings=Original Total Bill−New Total Bill

In this case, Total Savings=$34−$27.62=$6.38. Alternatively, the savings can be calculated directly from the new usage of 276.2 kWh, by calculating a total bill savings in tier 2 of (320 kWh−300 kWh)×$0.20/kWh=$4.00 and in tier 1 (300 kWh−276.2 kWh)×$0.10/kWh=$2.38, for a total savings of $4.00+$2.38=$6.38.
The Average per KWh Savings can then be calculated from:

Average per kWh Savings=Total Savings/Usage Savings

This provides a total savings for these two sets of bulbs of $6.38 for the 43.8 total kWh reduction and an Average per kWh Savings of $6.38/43.8 kWh=$0.146/kWh. If desired (e.g. selected by user), the system can present the savings for any configuration of bulb groupings. For example, if the user selects to evaluate only the kitchen island switch, the system estimates the new usage of 320 kWh−28.8 kWh=291.2 kWh, calculates a new Total Bill of $29.12, Total Savings of $4.88, and an Average per kWh Savings of $4.88/28.8 kWh=$0.169/kWh.

In the above illustrative example, the system can also present summary data for costs, payback periods, investment return, convenience of not changing bulbs due to longer life, and/or environmental impact that result from changing bulbs. In one embodiment, the system calculates the estimated size and cost of a solar power system that would produce the same electricity as the more efficient bulbs would be expected to save using standard techniques for sizing a solar system and typical costs of installed solar power systems. The equivalent solar system calculation can be based on the on the solar profile for the premises location or another location, if desired.

In one embodiment, the system tracks the total environmental impact for a user by including the user's environmental impact, the environmental impact of those referred to the service by the user, and/or the environmental impacts of all of the referred users' referrals (and so on for all subsequent referrals). Similarly, the environmental impact for a group of people can be tracked and the environmental impact from a partial or full series of referrals for that group can also be tracked.

### 4. Select Products for Purchase Using Savings and Priority Data

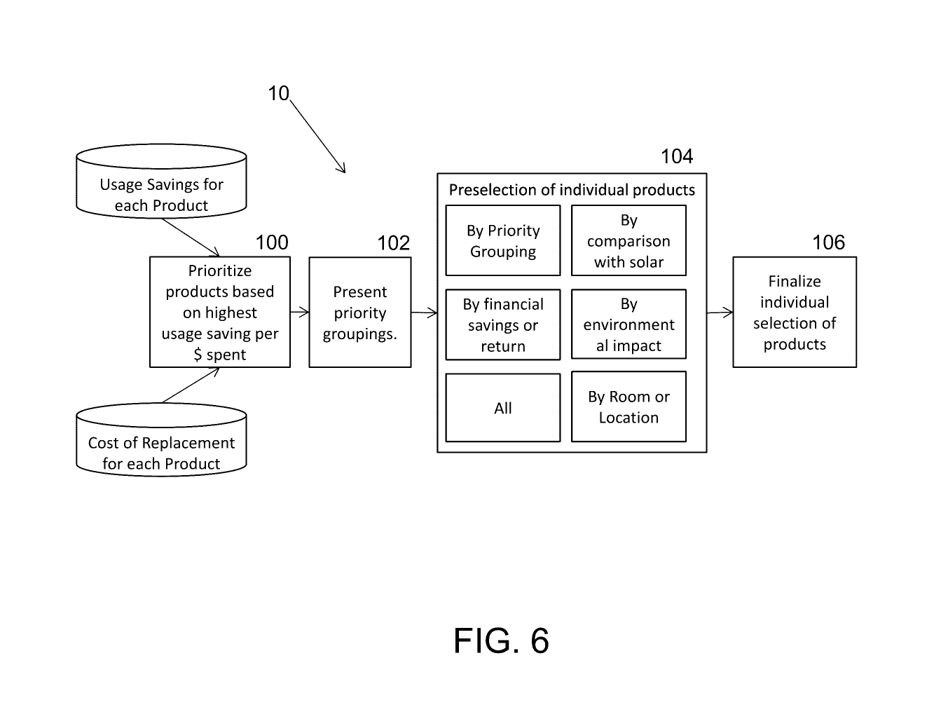

A process 10 for selecting bulbs for purchase using savings and priority data in accordance with an embodiment of the present technology is illustrated in FIG. 6. With the usage savings for each bulb and the cost of replacement bulbs, the system prioritizes products based on the highest usage savings per dollar spent (100). The system provides a prioritized list or groupings by priority (e.g., high, medium, low) to the user (102). The user can select grouping of bulbs for purchase based on one or more criteria that can include selection by priority grouping (e.g., all high, all high and medium), by financial return (e.g., bulbs with >30% return), by comparison with solar (e.g., all bulbs cheaper than installing solar power), by environmental impact (e.g. lbs of CO2 eliminated), and/or by room (104). The user can select the bulbs that they would like to replace and the system dynamically updates financial, convenience, and environmental impact calculations. The user then finalizes selection of bulbs for replacement (106).

In one embodiment, the system selects the specific bulbs directly for the user based on desired features for the replacement bulb types for some or all bulbs (e.g., the user does not know the brands of bulbs that will be received with purchase). In other embodiments, the system may present options for users to select from one or more known brands of bulbs.

Continuing the above example, the system calculates that the kitchen island bulbs will save 28.8 kWh per 30 day period for a total cost of 6*$15=$90 or save 28.8 kWh/$90=0.32 kWh for 30 days per dollar and the main living room bulbs will save 15 kWh per 30 day period for a total cost of 10*$10=$100 or save 15 kWh/$100=0.15 kWh for 30 days per dollar. In one embodiment, the system prioritizes bulbs based on the average savings rate for a selected set of bulbs. For example, if including both sets of bulbs, the average savings rate (as calculated in section 3) was $0.146/kWh. While the system can adjust for monthly variations in usage and billing as well as # of days in billing cycle, this simplified example assumes every month is 30 days with 320 kWh expected total usage and constant electricity rates throughout the year. The payback for the kitchen island bulbs is $90/(28.8 kWh/mo*$0.146)=21.5 months and the payback for the main living room bulbs is $100/(15 kWh/mo*$0.146)=45.8 months. If the system categorizes high priority bulbs as less than 2 year payback and medium priority as less than 4 year payment, then the kitchen island bulbs would be high priority and main living room would be medium priority.

In another embodiment, the system applies the above formulas to individual bulb groupings in order based on the highest usage saving per dollar spent (or equivalent measure). The system, in accordance with various embodiments, can first perform calculations for the highest priority bulb grouping to determine the Usage Savings, New Total Bill (or alternatively calculate savings directly), and Average per kWh Savings. Then the system can repeat for each set of bulbs where the end values (e.g., Total Bill) from the prior calculations are used as initial values for next set of bulbs.

In the above example, some embodiments of the system can first perform calculations for the kitchen island bulbs. With a Total Usage of 320 kWh and Usage Savings for the kitchen island bulbs of 28.8 kWh, the system can calculate a new Total Bill of $29.12, Total Savings of $4.88, and an Average per kWh Savings of $4.88/28.8 kWh=$0.169/kWh. So, the payback for the kitchen island bulbs is $90/(28.8 kWh/mo*$0.169)=18.5 months. Next, some embodiments of the system can perform calculations for the main living room bulbs using the results from the previous step (Total Bill of $29.12 and new Total Usage of 320 kWh−28.8 kWh=291.2 kWh) as inputs. For the main living room bulbs, the system then calculates a new Total Usage of 291.2 kWh−15 kWh=276.2 kWh, a Total Bill of $27.62, Total Savings of $1.50, an Average per kWh Savings of $0.10/kWh and a payback for the main living room bulbs of $100/$1.50/mo=66.7 months. The kitchen island bulbs would be high priority and since the main living room bulbs payback is now greater than 4 years, these bulbs would be low priority.

The system, in accordance with one or more embodiments, can perform the above calculation by only including selected bulbs in the prioritization. For example, if the user selected to replace the main living room bulbs and selected not to change the kitchen island bulbs, then the system calculates using the above formulas that the new Total Usage would be 320 kWh−15 kWh=305 kWh, that all the usage savings would be at the tier 2 rate of $0.20/kWh, with a savings of 15 kWh*$0.20/kWh=$3 per month, and a payback of $100 bulb cost/$3 per month savings=33.3 months so these bulbs would now be a medium priority.

### 5. Purchase or Lease Desired Products

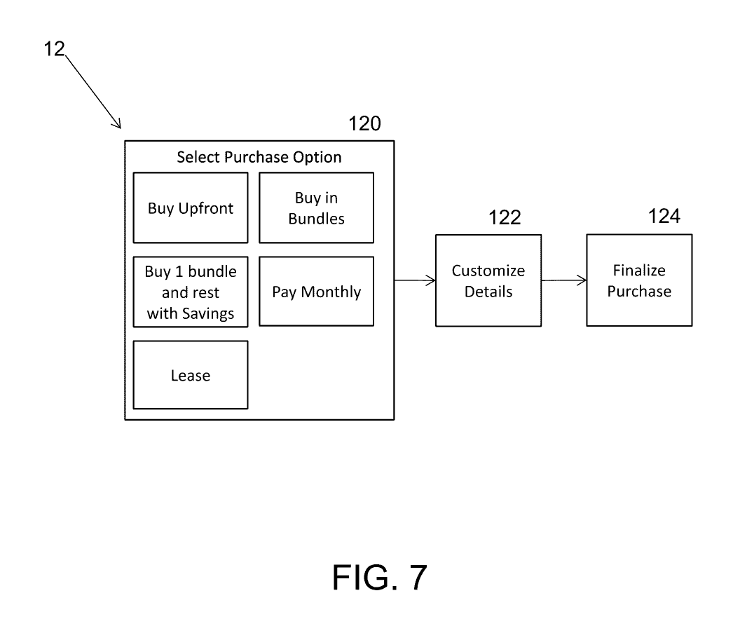

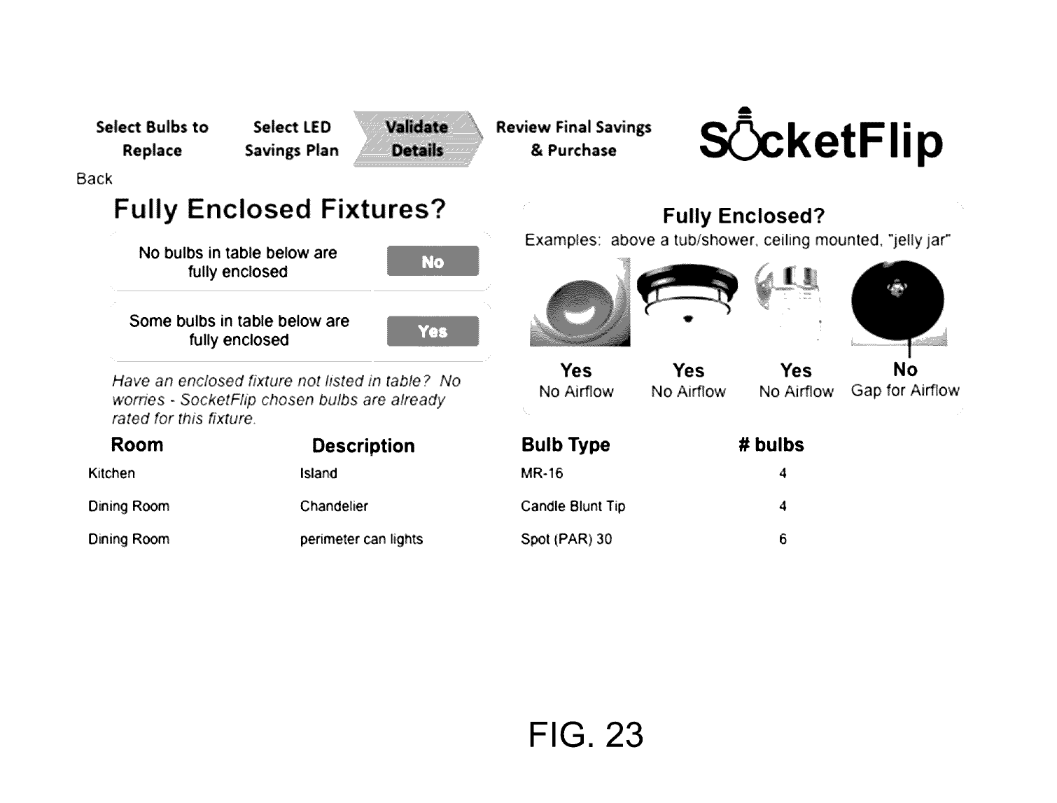

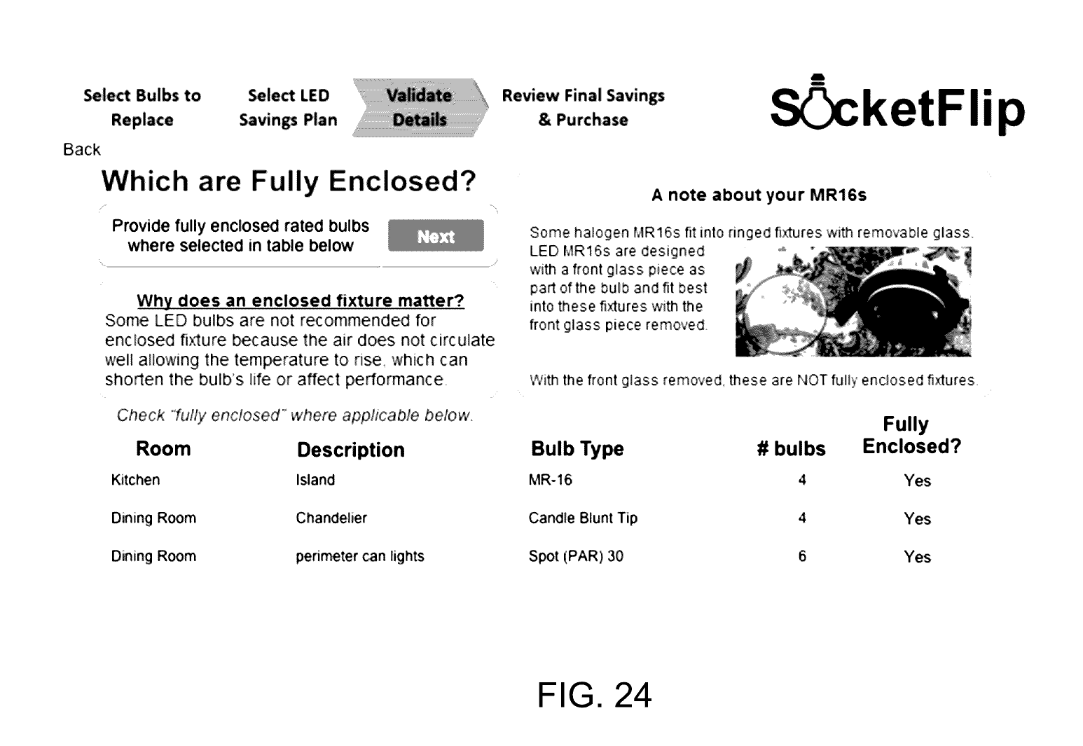

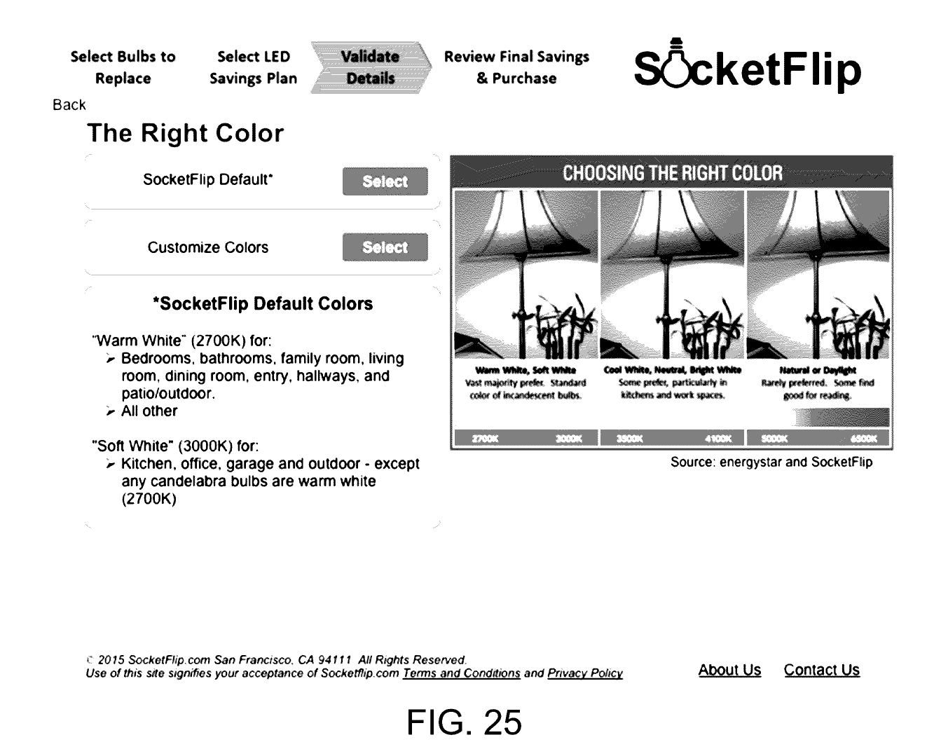

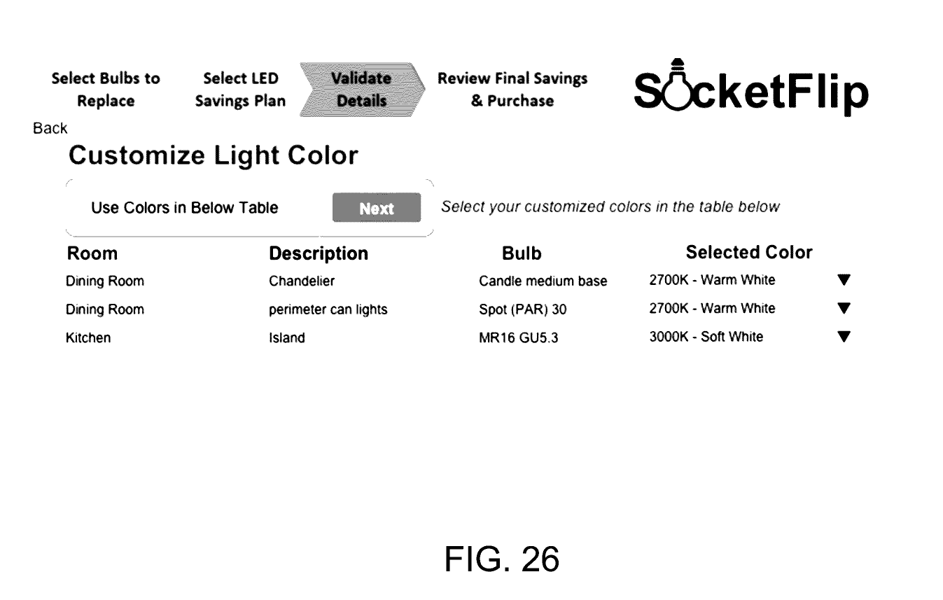

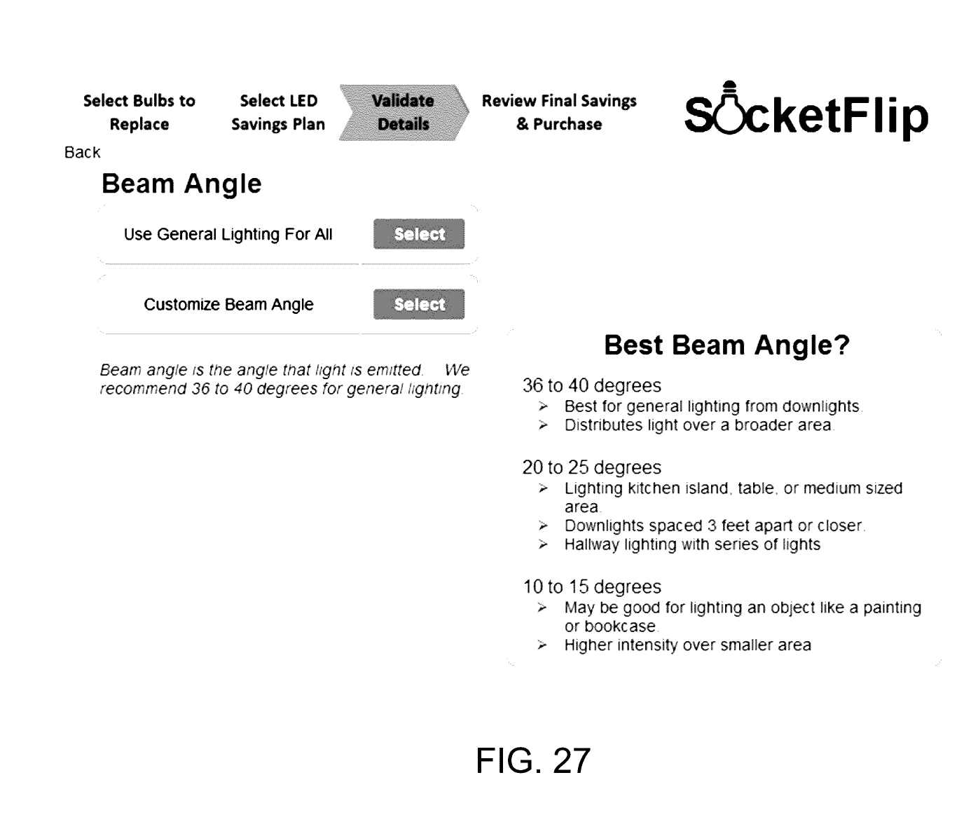

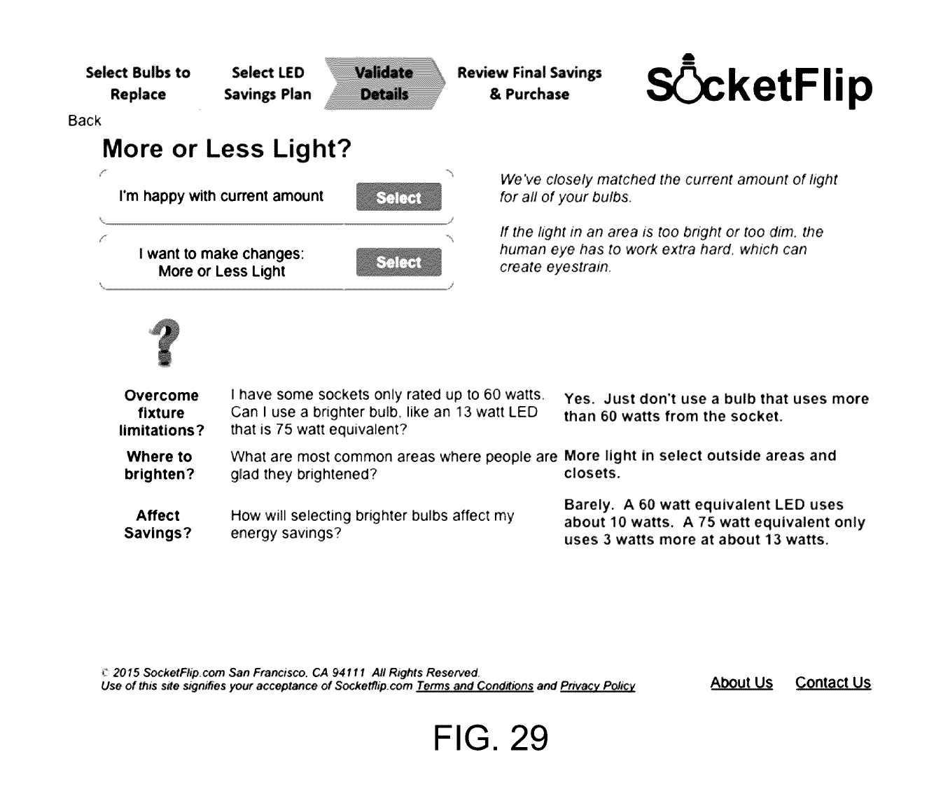

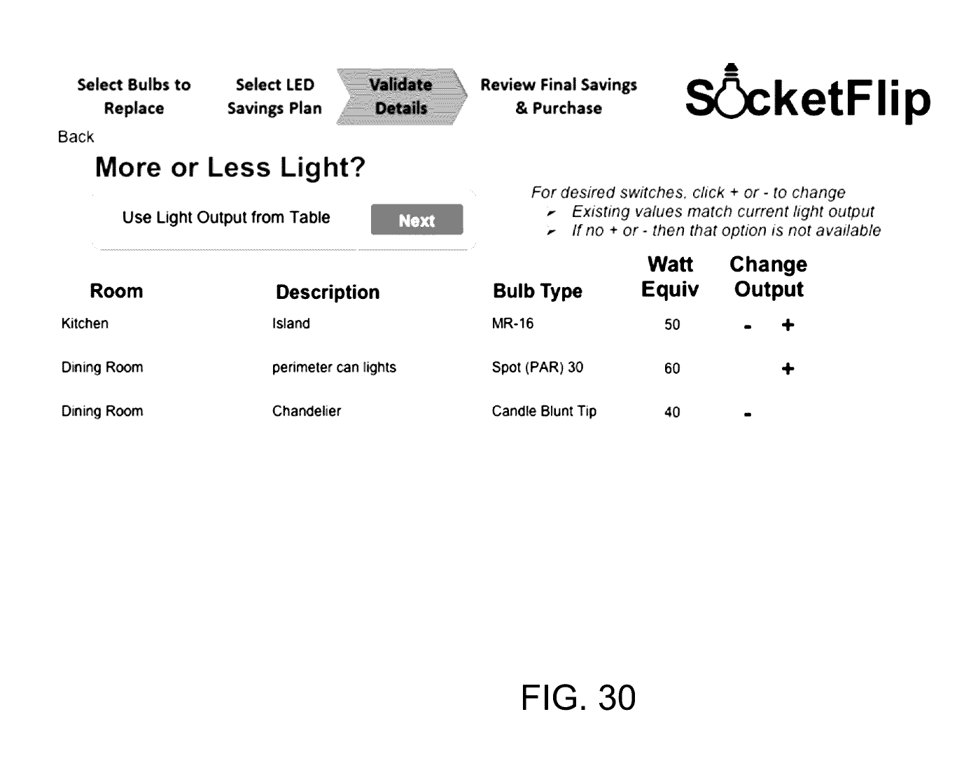

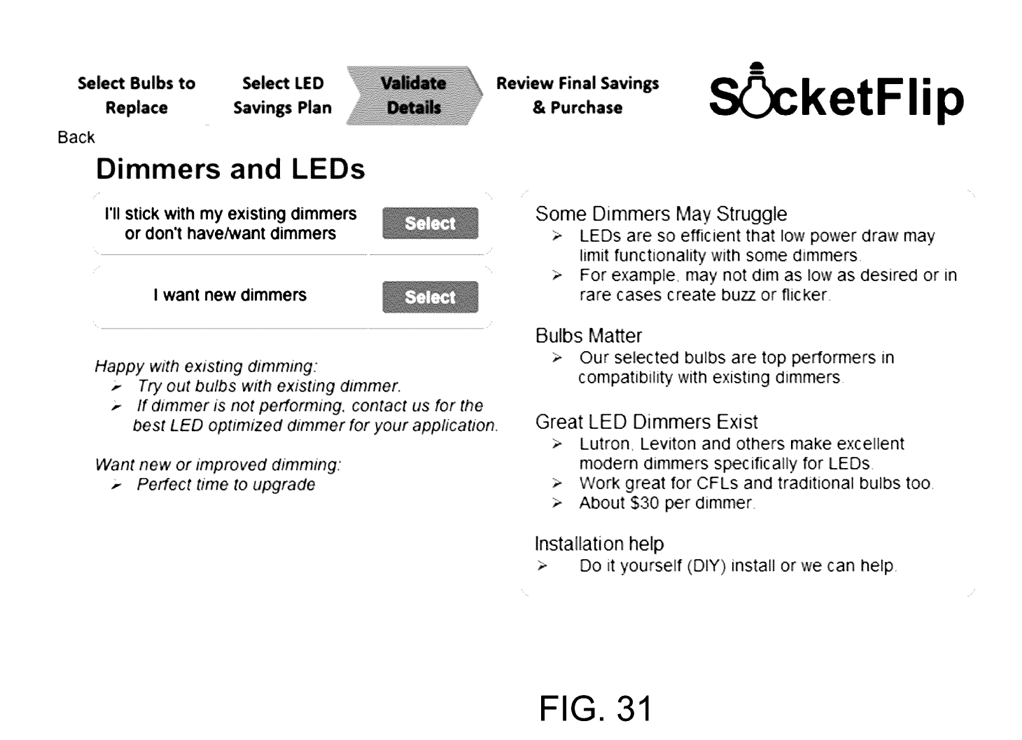

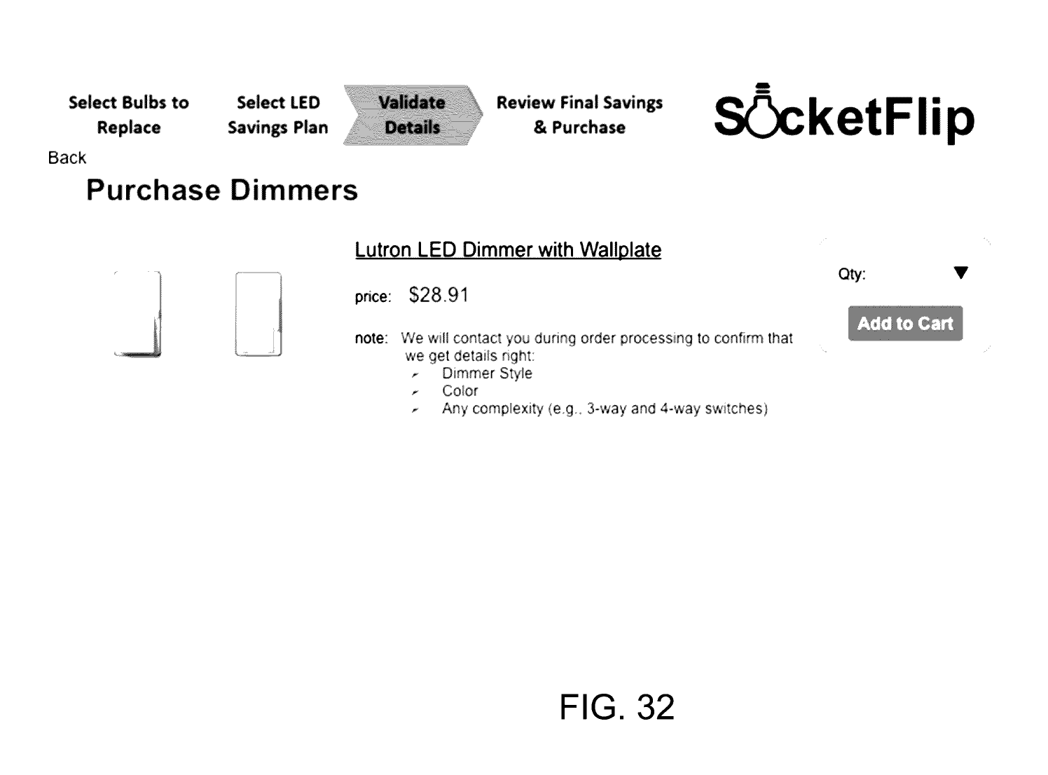

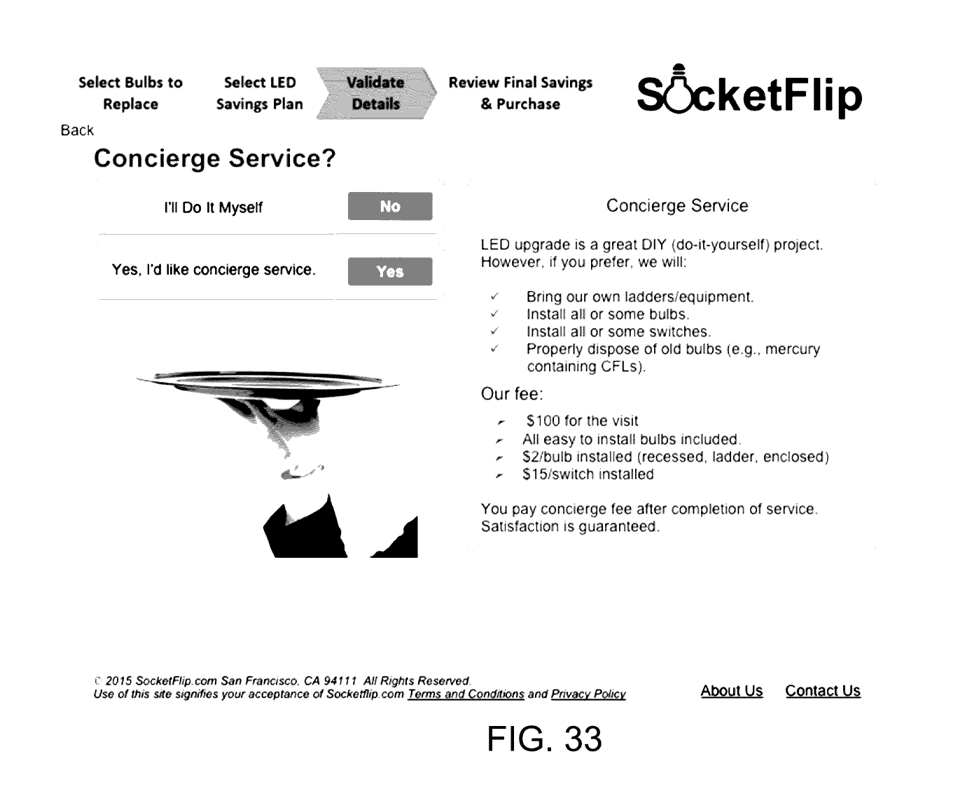

A process 12 for purchasing or leasing desired products in accordance with an embodiment of the present technology is illustrated in FIG. 7. For the products selected for purchase, the user can be offered a variety of purchase options that can include buy upfront, buy in bundles, pay for products with a monthly payments, lease the products, or methods to buy with savings. For the buy in bundles option, the system can allow the user to create 2 or more bundles and select bulbs to include in each bundle. A unique buy with savings option can allow the user to buy some bulbs, track the savings from those bulbs, provide one or more purchase options to buy additional bulbs with the savings, and repeat, until all bulbs are purchased, with each installed bulb contributing to the savings totals (120). The system can provide a streamlined customization process. The system obtains details for the bulb purchase through an express process that uses system defaults or predefined packages and/or allows customization. Items in customization can include the following:
Fully Enclosed: Since some bulbs in the market are not certified for fully enclosed fixtures, the system can request (see, e.g., FIGS. 23-24) the user to select whether bulbs are fully enclosed. However, the system only requests this information for a set of bulbs if the system selected replacement bulbs are not rated for fully enclosed fixtures.
Light Color: There are various colors of white light available from light bulbs. The user can select from one or more color package options (e.g., warm white for all except soft white in kitchen) or customize colors. Where a user selects to customize colors, the system only presents available color options from the replacement bulb options in the system (see, e.g., FIGS. 25-26).
Beam Angle: Since some bulbs have choices of beam angle for dispersion of light (e.g., 15 degrees, 25 degrees, 40 degrees), the system allows the user to customize beam angle (see, e.g., FIGS. 27-29). Again, the system only requests this information for a set of bulbs if more than one beam angle is available for that specific bulb type in the replacement bulb database.
Amount of light (i.e., lumens): For each user specified bulb grouping, the system identifies if there are options for more or less light for the bulb type and presents those to the user (see, e.g., FIGS. 29-30). The system can present for all bulb grouping or only those with options available.
Dimmers: The user can purchase dimmers that are compatible with the bulbs being purchased. (see, e.g., FIGS. 31-32)
Concierge: The user can select a concierge service to install bulbs and selected dimmers. (see, e.g., FIG. 33)
Connected Bulbs and/or Switches: The user can select dimmers and/or bulbs that can be remotely controlled using powerline or wireless communication technology. These devices can often be controlled using smartphones, tablets, and/or computers. Additionally, advanced devices can provide data on the electricity usage of the device directly and/or data to allow usage to be calculated, or operating information that can be used to calculate the electricity usage where the watt rating of the bulb(s) are known.

The user then can finalize the purchase (124). In one embodiment, the connected switches are/or bulbs are preprogrammed for the specific location where the devices will be placed. In that way, the consumers can get avoid set-up work that has been a barrier to entry for adoption of connected switches.

### 6. Calculate or Estimate Actual Savings

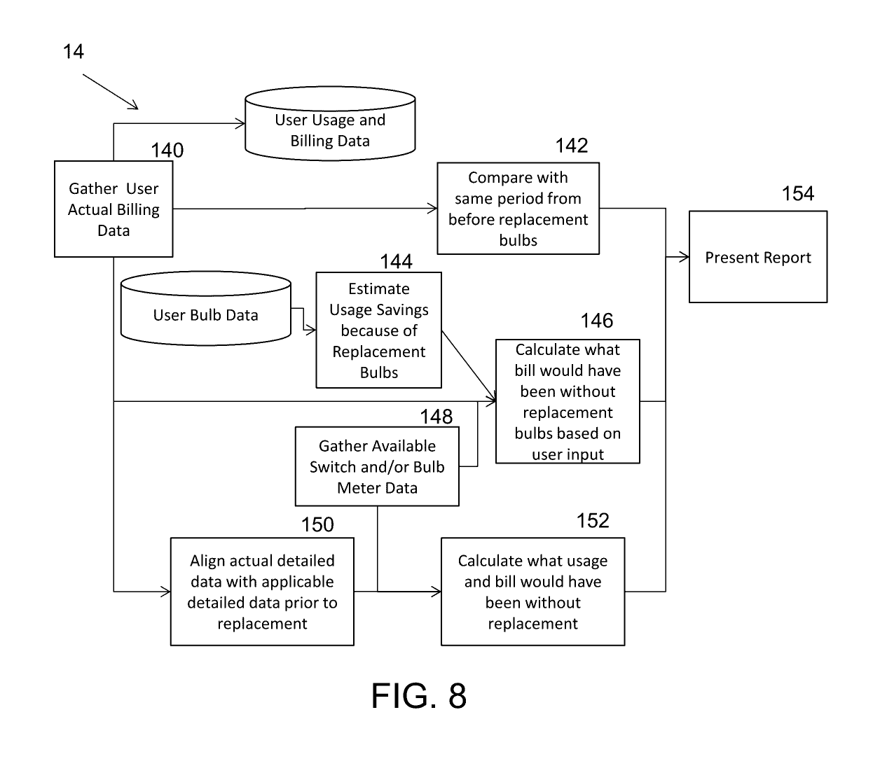

A process 14 for calculating or estimating the actual savings from having installed replacement bulbs in accordance with an embodiment of the present technology is illustrated in FIG. 8. The system obtains access to customer billing data from the user or directly from the user's ESP and stores data in the system (140). The system can perform a simple comparison with the actual billing data with the equivalent period from prior to replacing bulbs (e.g., April 2015 compared with April 2014 if bulbs replaced in January 2015). The system can also calculate the expected usage savings due to the installed replacement bulbs using data from the replacement bulbs and information in the user bulb data database including hours of operation for bulbs and previous bulb watts (144). It then can calculate what the bill would have been with this additional usage and calculate the savings based on this user entered data (146). Bulb hours of operation can be based on previously entered hours (e.g., upon initial assessment), updated hourly usage, or actual operating data available from connects bulbs and/or switches (or usage data directly from these devises) (146).

The system can also estimate the savings by comparing detailed usage data (e.g., hourly data for the full billing period) with equivalent days of the week (e.g., Monday aligned with Monday, etc.) from a similar time period prior to replacing bulbs (150). This alignment can include identifying days that are not good comparisons (e.g., user is on vacation a week in 2014, but not in 2015) and substitute representative days to better align savings estimations. With the full set of aligned days for the actual data being analyzed, the system totals the usage from prior to replacing bulbs and calculates what the usage and bill would have been without replacing bulbs (152). For example, a user installs replacement bulbs in January of 2015. To analyze the billing period from Apr. 1, 2015 (Wednesday) to Apr. 30, 2015 (Thursday), the system aligns days for a comparison of data directly with Apr. 2, 2014 (also Wednesday) to May 1, 2015 (also Thursday). Some embodiments of the system can also use other methods to compare usage based on the day of the week, such as comparing averages for a given time of year (e.g., average Monday in April from before and after replacing bulbs).

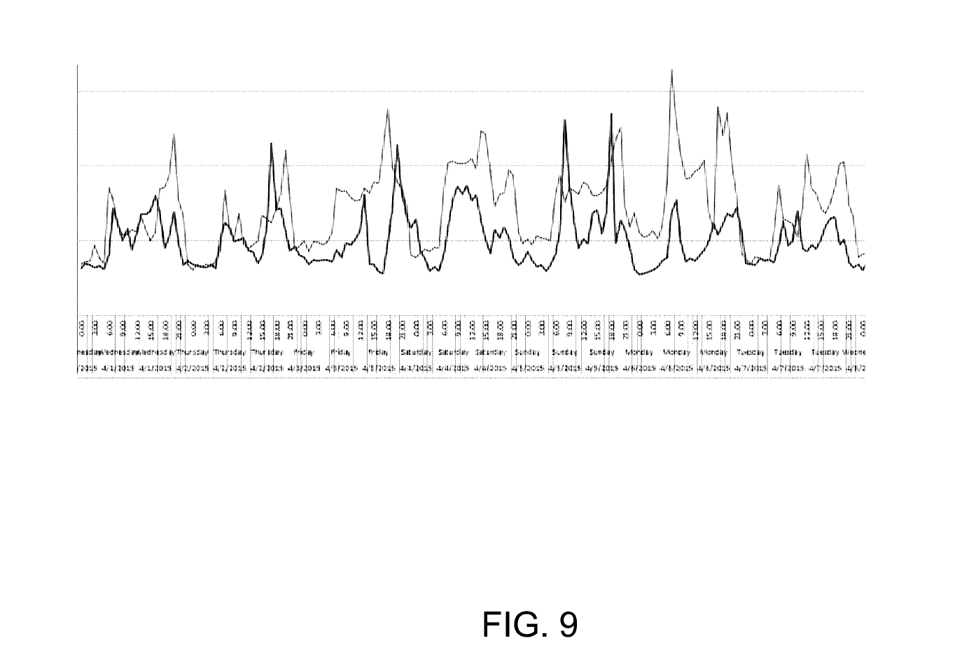

FIG. 9 shows an example of the comparison of hourly usage data for a user for one week within this billing period. Because usage often varies by day of the week, this presentation allows a better comparison of the data before and after changing bulbs. In FIG. 8, the line that is generally lower is the 2015 data shows the 2015 reduction in usage. In this case, the system estimated 250 kWh of savings for the month of April and calculated actual savings of 243.1 kWh. The system present one or more of these analyses to the user (154). The system can also provide information on additional benefits such as the convenience associated with the number of bulbs (and associated cost) of not having to replace bulbs with a shorter life and environmental benefits for the time period.

The system can also apply adjustments based on known upgrades (e.g., new more efficient refrigerator) in the premises to better isolate the savings due to replacement bulbs.

In another embodiment, the system allows individual users to be grouped to track the financial, convenience, and/or environmental impact for a plurality of individuals within a desired group.

### Representative Embodiments

The following examples provide representative embodiments of the present technology. In other embodiments, aspects of these examples can be combined or eliminated in any of a variety of suitable manners.
A system and method for inventorying bulbs, assessing benefits and cost of replacements, customizing bulb features, and purchasing.
A system and method to estimate user specific usage and rates with minimal information from the user.
A system and method for calculating savings for selected sets of bulbs.
A system and method for calculating savings for selected sets of bulbs in a tiered rate structure.
A system and method to inventory existing bulbs by gathering required information through a graphical user interface.
A system and method to use a floor plan for the bulb inventory process.
A system and method for controlling lighting from floor plan based graphical user interface.
A system and method for identifying bulb types with camera images and/or videos.
A system and method to prioritize bulb purchases.
A system and method to equate energy efficient lighting upgrades to solar power systems.
A system and method to match replacement bulbs to existing bulbs.
A system and method for users to lease led bulbs.
A system and method for bundling bulb purchases.
A system and method to pay for bulbs with savings.
A system and method to estimate the actual savings generated by a user's installed bulbs
A system and method to match replacement bulbs using lumen data gathered from a smart phone or tablet.

Herein, various embodiments of the systems apply to LED lighting or other solid state lighting technology such as emerging OLED lighting, other solid state lighting technologies, or other energy efficient lighting technologies.

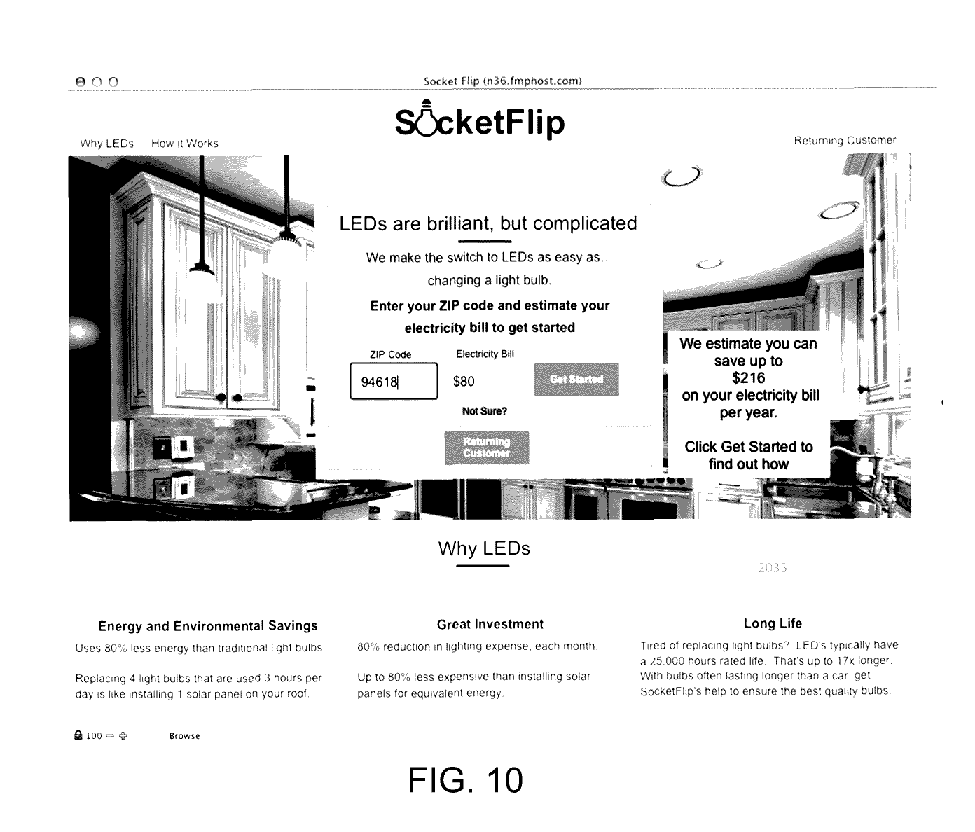

FIGS. 10-36 are example screenshots of graphical user interfaces that can be used in accordance with some embodiments of the present technology. FIG. 10 illustrates an example of a graphical user interface for collecting location information along with information about the user's electric bill. FIG. 11 illustrates an example of a graphical user interface that can be used to collect information about a user's bulbs in a room-by-room fashion. Once a user selects a room in FIG. 11, FIG. 12 can be used to collect specific bulb information. Upon selecting a specific type of bulb, an additional option GUI for refining the bulb type can be presented as illustrated in FIG. 13. FIG. 14 allows a user to enter information about the bulbs including a location description, number of bulbs, watts, hours/day of use, and the type of technology (e.g., halogen).

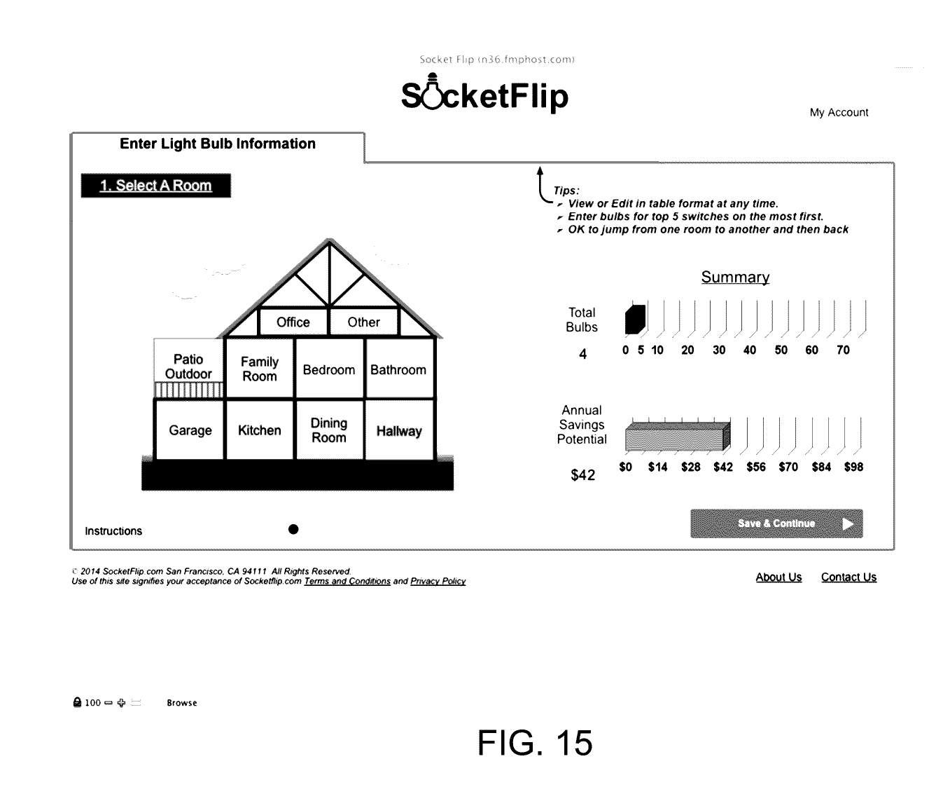

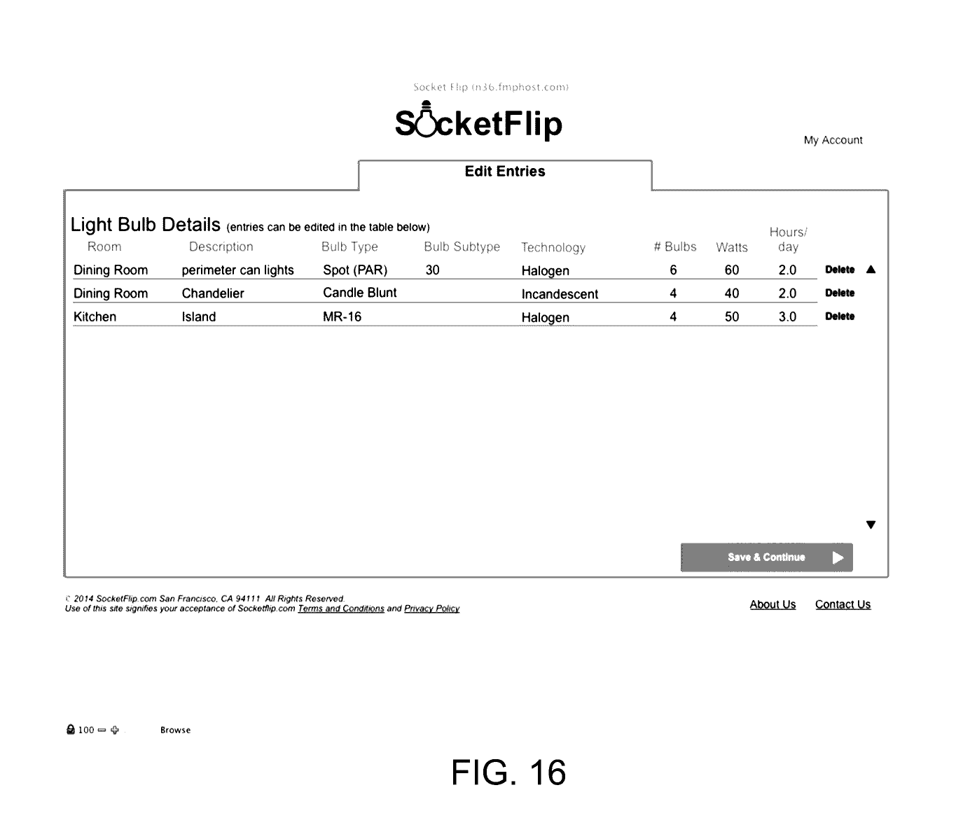

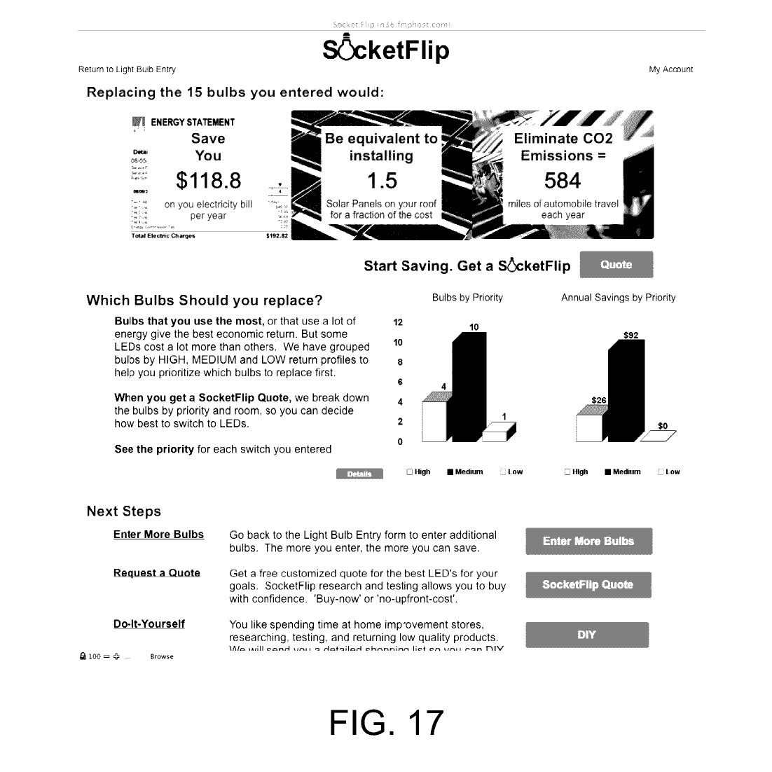

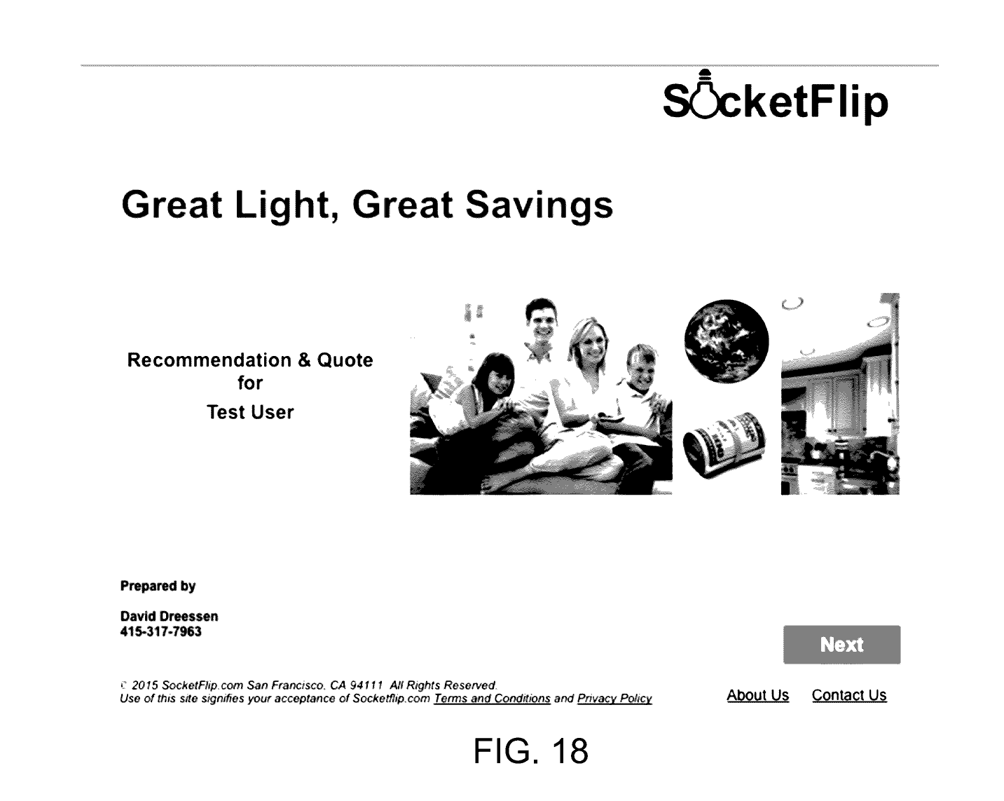

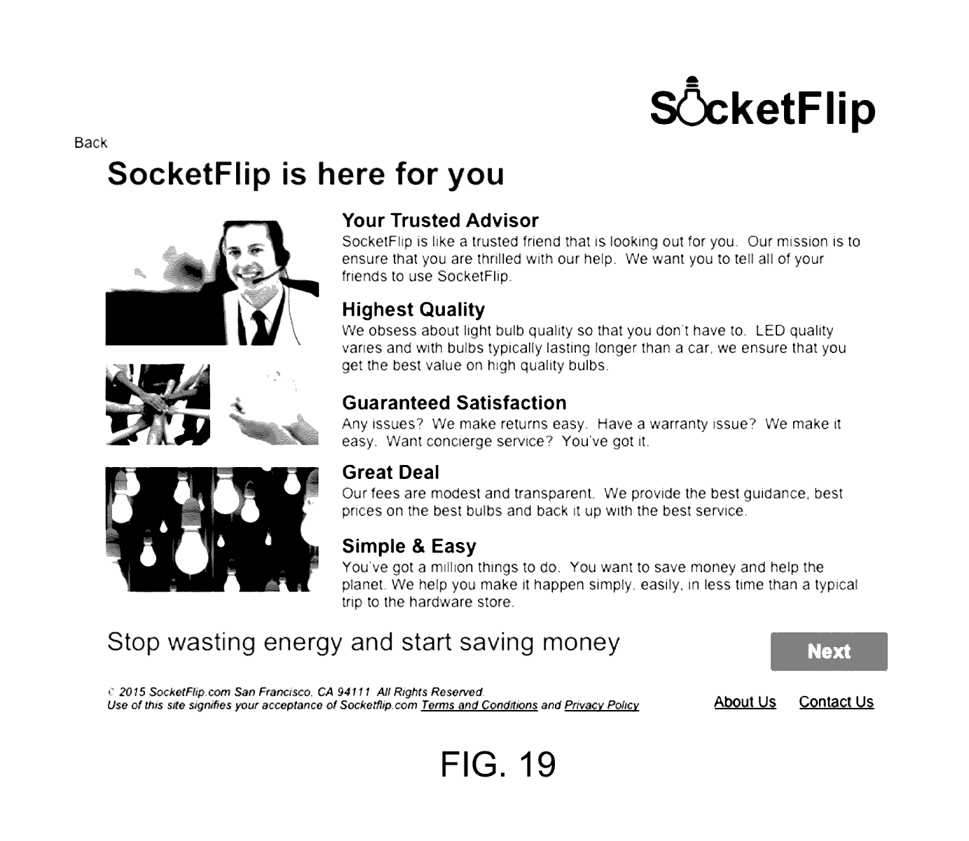

FIG. 15 illustrates an example of a graphical user interface similar to FIG. 11 once the bulb summary and savings summary have been entered and computed. FIG. 16 illustrates an example of a graphical user interface for editing light bulb details that have been entered into the system. FIG. 17 illustrates an example of a graphical user interface for summarizing the savings by replacing the current bulbs with more energy efficient bulbs and a prioritization (e.g., high, medium, low) based on potential savings. FIG. 18 illustrates an example of a graphical user interface for generating a recommendation and quote for a user. FIG. 19 illustrates an example of a graphical user interface highlighting many of the benefits of the technology.

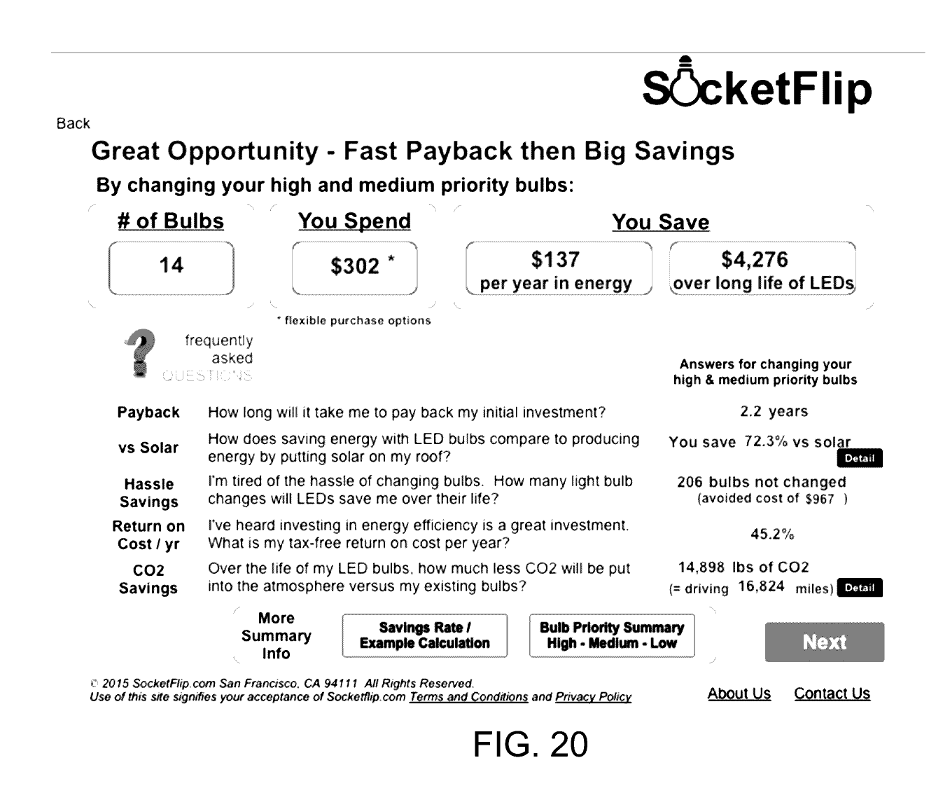

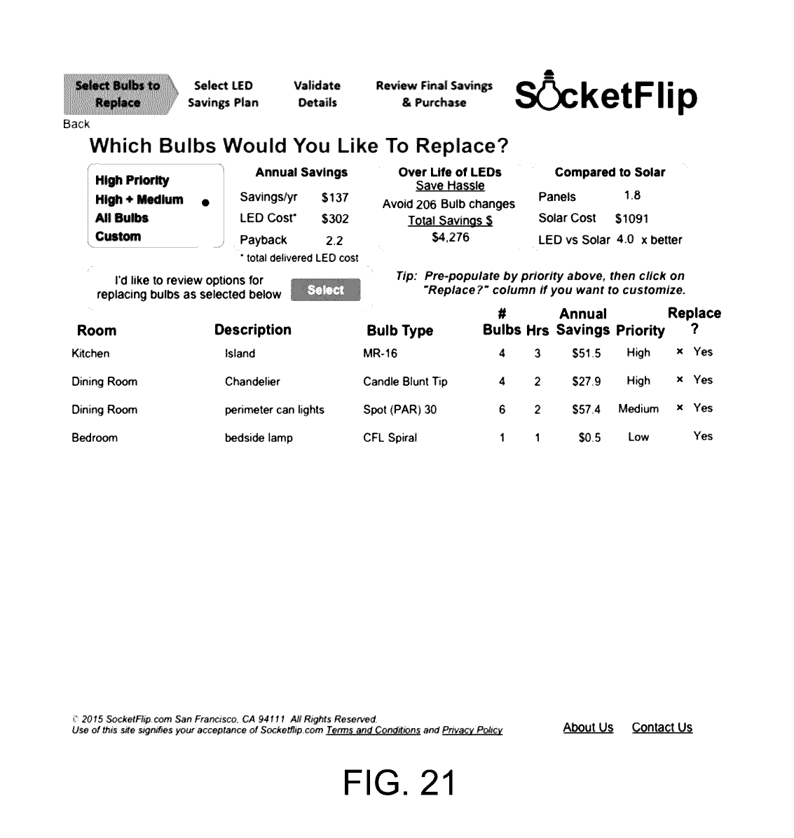

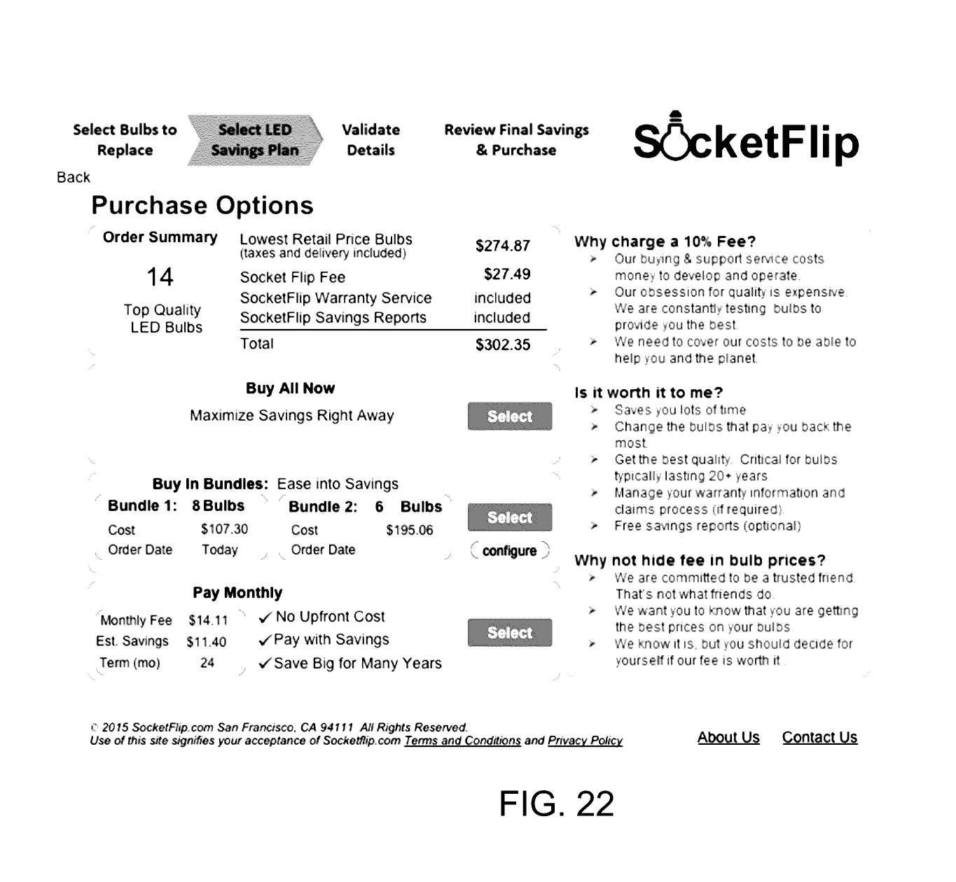

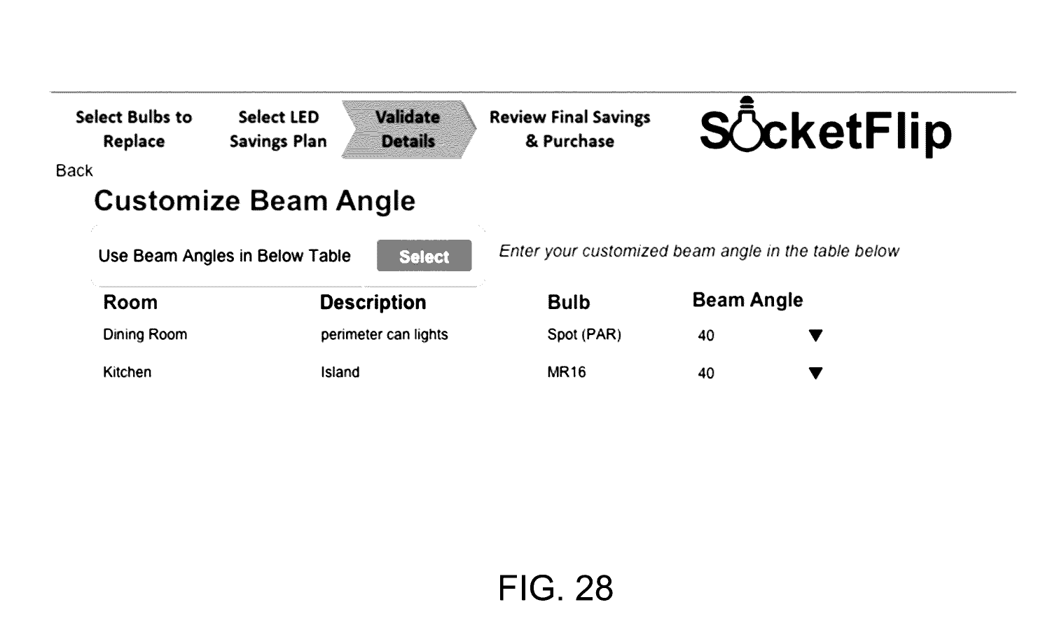

FIG. 20 illustrates an example of a graphical user interface illustrating the fast payback and savings of replacing current lights with more efficient bulbs. FIG. 21 illustrates an example of a graphical user interface that allows a user to select which bulbs they would like to replace (e.g., high priority, high and medium priority, all, custom, etc.). FIG. 22 illustrates an example of a graphical user interface highlight various purchase options which are available through the system. FIGS. 23 and 24 illustrate examples of graphical user interfaces for identifying which fixtures are enclosed. FIGS. 25 and 26 illustrate examples of graphical user interfaces for selecting the right color of light. FIGS. 27-28 illustrate examples of graphical user interfaces for selecting the beam angle for each fixture. FIGS. 29 and 30 illustrate examples of graphical user interfaces for adjusting the amount of light for each fixture. FIGS. 31 and 32 illustrate examples of graphical user interfaces for ordering dimmers.

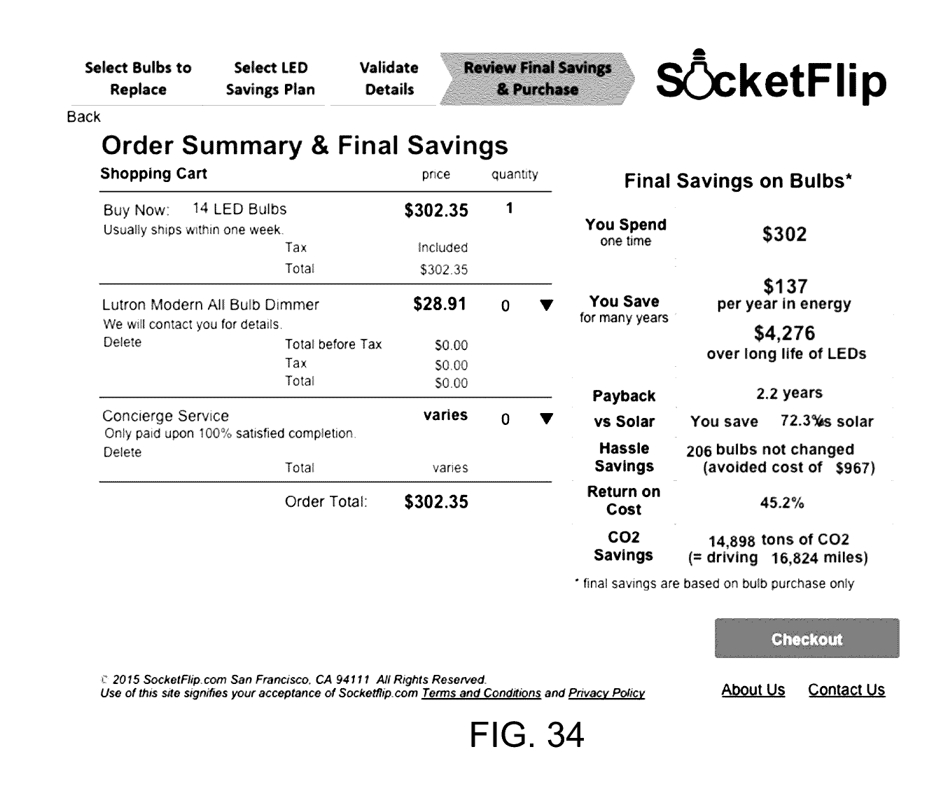

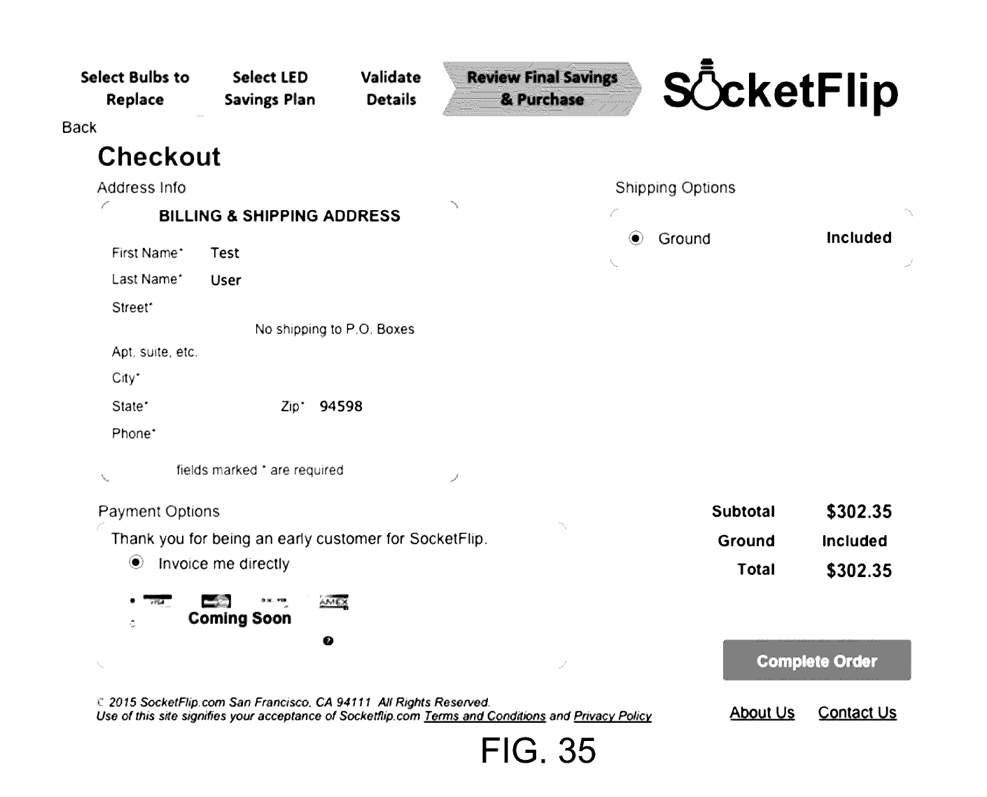

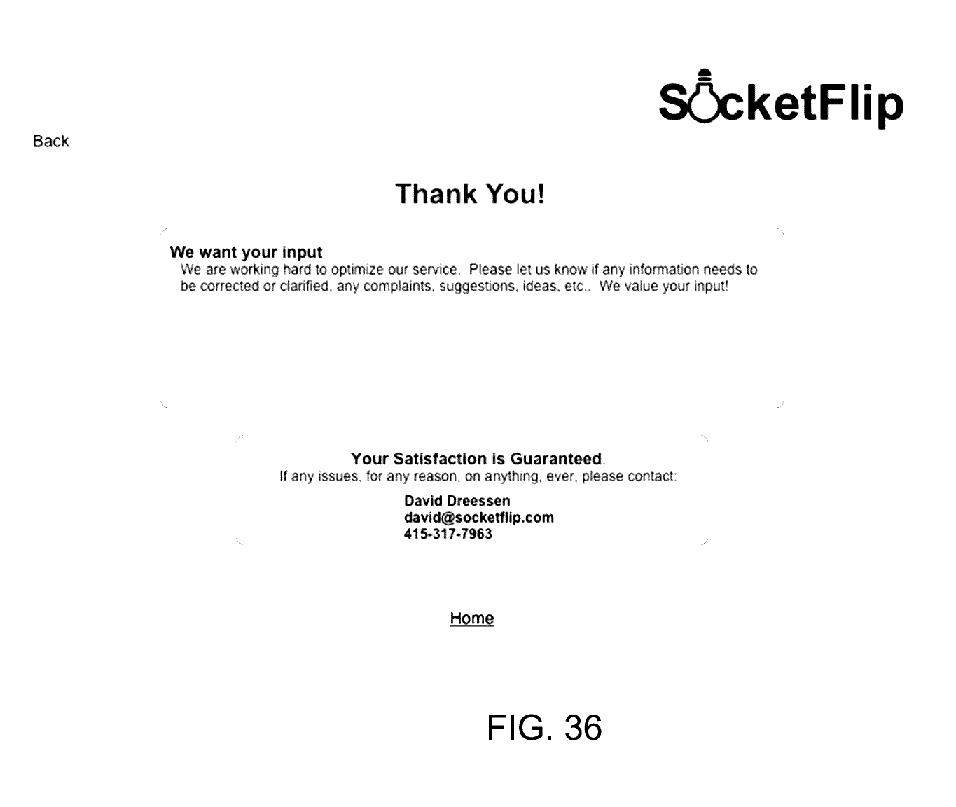

FIG. 33 illustrates an example of a graphical user interface allowing the user to select the concierge service. FIG. 34 illustrates an example of a graphical user interface summarizing the order and the estimated savings resulting from replacement of the bulbs. FIG. 35 illustrates an example of a graphical user interface allowing the user to checkout and purchase the bulbs, dimmers, and/or installation service. FIG. 36 illustrates an example of a graphical user interface for collecting feedback from the user.

### Representative Computer System Overview

Aspects and implementations of the efficiency system of the disclosure have been described in the general context of various steps and operations. A variety of these steps and operations can be performed by hardware components or can be embodied in computer-executable instructions, which can be used to cause a general-purpose or special-purpose processor (e.g., in a computer, server, or other computing device) programmed with the instructions to perform the steps or operations. For example, the steps or operations can be performed by a combination of hardware, software, and/or firmware.

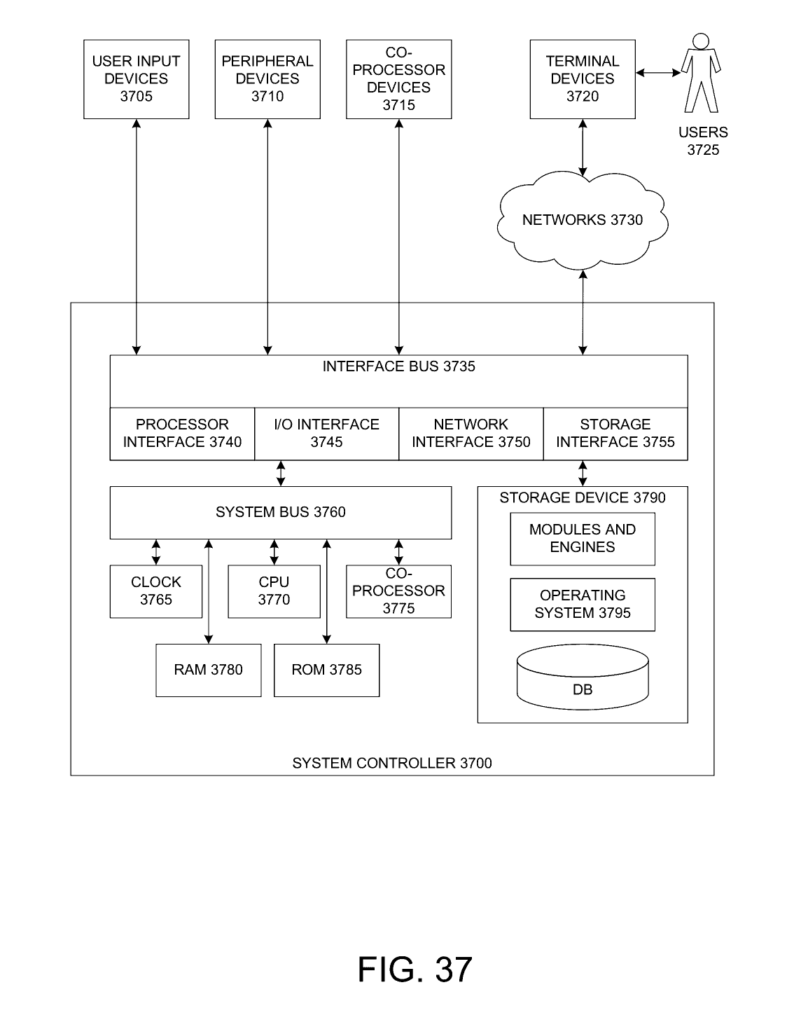

FIG. 37 is a block diagram illustrating an example machine representing the computer systemization of the efficiency system. The efficiency system controller 3700 can be in communication with entities including one or more users 3725 client/terminal devices 3720 (e.g., devices 110A-110N), user input devices 3705, peripheral devices 3710, an optional co-processor device(s) 3715 (e.g., cryptographic processor devices), and networks 3730 (e.g., 115 in FIG. 1). Users can engage with the controller 3700 via terminal devices 3720 over networks 3730.

Computers can employ a central processing unit (CPU) or processor to process information. Processors can include programmable general-purpose or special-purpose microprocessors, programmable controllers, application-specific integrated circuits (ASICs), programmable logic devices (PLDs), embedded components, combination of such devices and the like. Processors execute program components in response to user and/or system-generated requests. One or more of these components can be implemented in software, hardware or both hardware and software. Processors pass instructions (e.g., operational and data instructions) to enable various operations.

The controller 3700 can include clock 3765, CPU 3770, memory such as read only memory (ROM) 3785 and random access memory (RAM) 3780 and co-processor 3775 among others. These controller components can be connected to a system bus 3760, and through the system bus 3760 to an interface bus 3735. Further, user input devices 3705, peripheral devices 3710, co-processor devices 3715, and the like, can be connected through the interface bus 3735 to the system bus 3760. The interface bus 3735 can be connected to a number of interface adapters such as processor interface 3740, input output interfaces (I/O) 3745, network interfaces 3750, storage interfaces 3755, and the like.

Processor interface 3740 can facilitate communication between co-processor devices 3715 and co-processor 3775. In one implementation, processor interface 3740 can expedite encryption and decryption of requests or data. Input output interfaces (I/O) 3745 facilitate communication between user input devices 3705, peripheral devices 3710, co-processor devices 3715, and/or the like and components of the controller 3700 using protocols such as those for handling audio, data, video interface, wireless transceivers, or the like (e.g., Bluetooth, IEEE 1394a-b, serial, universal serial bus (USB), Digital Visual Interface (DVI), 802.11a/b/g/n/x, cellular, etc.). Network interfaces 3750 can be in communication with the network 3730. Through the network 3730, the controller 3700 can be accessible to remote terminal devices 3720. Network interfaces 3750 can use various wired and wireless connection protocols such as, direct connect, Ethernet, wireless connection such as IEEE 802.11a-x, and the like.

Examples of network 3730 include the Internet, Local Area Network (LAN), Metropolitan Area Network (MAN), a Wide Area Network (WAN), wireless network (e.g., using Wireless Application Protocol WAP), a secured custom connection, and the like. The network interfaces 3750 can include a firewall which can, in some aspects, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall can additionally manage and/or have access to an access control list which details permissions including, for example, the access and operation rights of an object by an individual, a machine, and/or an application, and the circumstances under which the permission rights stand. Other network security functions performed or included in the functions of the firewall, can be, for example, but are not limited to, intrusion-prevention, intrusion detection, next-generation firewall, personal firewall, etc., without deviating from the novel art of this disclosure.

Storage interfaces 3755 can be in communication with a number of storage devices such as, storage device(s) 3790, removable disc devices, and the like. The storage interfaces 3755 can use various connection protocols such as Serial Advanced Technology Attachment (SATA), IEEE 1394, Ethernet, Universal Serial Bus (USB), and the like.

User input devices 3705 and peripheral devices 3710 can be connected to I/O interface 3745 and potentially other interfaces, buses and/or components. User input devices 3705 can include card readers, finger print readers, joysticks, keyboards, microphones, mouse, remote controls, retina readers, touch screens, sensors, and/or the like. Peripheral devices 3710 can include antenna, audio devices (e.g., microphone, speakers, etc.), cameras, external processors, communication devices, radio frequency identifiers (RFIDs), scanners, printers, storage devices, transceivers, and/or the like. Co-processor devices 3715 can be connected to the controller 3700 through interface bus 3735, and can include microcontrollers, processors, interfaces or other devices.

Computer executable instructions and data can be stored in memory (e.g., registers, cache memory, random access memory, flash, etc.) which is accessible by processors. These stored instruction codes (e.g., programs) can engage the processor components, motherboard and/or other system components to perform desired operations. The controller 3700 can employ various forms of memory including on-chip CPU memory (e.g., registers), RAM 3780, ROM 3785, and storage devices 3790. Storage devices 3790 can employ any number of tangible, non-transitory storage devices or systems such as fixed or removable magnetic disk drive, an optical drive, solid state memory devices and other processor-readable storage media. Computer-executable instructions stored in the memory can include the efficiency platform 120 having one or more program modules such as routines, programs, objects, components, data structures, and so on that perform particular tasks or implement particular abstract data types. For example, the memory can contain operating system (OS) component 3795, modules and other components, database tables, and the like. These modules/components can be stored and accessed from the storage devices, including from external storage devices accessible through an interface bus.

The database components can store programs executed by the processor to process the stored data. The database components can be implemented in the form of a database that is relational, scalable and secure. Examples of such database include DB2, MySQL, Oracle, Sybase, and the like. Alternatively, the database can be implemented using various standard data-structures, such as an array, hash, list, stack, structured text file (e.g., XML), table, and/or the like. Such data-structures can be stored in memory and/or in structured files.

The controller 3700 can be implemented in distributed computing environments, where tasks or modules are performed by remote processing devices, which are linked through a communications network, such as a Local Area Network (“LAN”), Wide Area Network (“WAN”), the Internet, and the like. In a distributed computing environment, program modules or subroutines can be located in both local and remote memory storage devices. Distributed computing can be employed to load balance and/or aggregate resources for processing. Alternatively, aspects of the controller 3700 can be distributed electronically over the Internet or over other networks (including wireless networks). Those skilled in the relevant art(s) will recognize that portions of the efficiency system can reside on a server computer, while corresponding portions reside on a client computer. Data structures and transmission of data particular to aspects of the controller 3700 are also encompassed within the scope of the disclosure.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number can also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations can perform routines having steps, or employ systems having blocks, in a different order, and some processes or blocks can be deleted, moved, added, subdivided, combined, and/or modified to provide alternative or subcombinations. Each of these processes or blocks can be implemented in a variety of different ways. Also, while processes or blocks are at times shown as being performed in series, these processes or blocks can instead be performed or implemented in parallel, or can be performed at different times. Further any specific numbers noted herein are only examples: alternative implementations can employ differing values or ranges.

The teachings of the technology provided herein can be applied to other systems, not necessarily the system described above. The elements and acts of the various examples described above can be combined to provide further implementations of the technology. Some alternative implementations of the technology can include not only additional elements to those implementations noted above, but also can include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system can vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, other aspects may likewise be embodied as a computer-readable medium claim, or in other forms, such as being embodied in a means-plus-function claim. Any claims intended to be treated under 35 U.S.C. §112(f) will begin with the words “means for”, but use of the term “for” in any other context is not intended to invoke treatment under 35 U.S.C. §112(f). Accordingly, the applicant reserves the right to pursue additional claims after filing this application to pursue such additional claim forms, in either this application or in a continuing application.

What is claimed is:

1. A system comprising:
a product database have stored thereon a plurality entries identifying information about lighting products,
wherein the information about each of the lighting products includes an energy usage indicator; and
a computing device having a processor, a display device and a memory, wherein the memory has stored thereon instructions corresponding to an efficiency application that when executed by the processor causes the computing device to collect lighting product information currently in use by a user via one or more graphical user interfaces displayed on the computing device,
wherein the one or more graphical user interfaces include:
a graphical user interface that is displayed on the display device allowing the user to enter, select, or validate identifying information regarding an energy provider;
a graphical user interface that is displayed on the display device presenting a room selection guide; and
a graphical user interface that is displayed on the display device, in response to a selection of a room from the room selection guide, and includes a product selection guide allowing the user to select one or more lighting products that are currently in use in the room and requests the user enter the number of hours each of the one or more lighting products is in use during a specified period of time;
an efficiency platform running on one or more servers and connected, via a network, to the computing device executing the efficiency application,
wherein the efficiency platform receives, from the efficiency application, the identifying information regarding the energy provider and information regarding the one or more lighting products that are currently in use;
wherein the efficiency platform retrieves electricity rates of the energy provider;
wherein the efficiency platform develops a replacement recommendation by identifying more efficient alternatives for each of the lighting products currently in use by the user; and
wherein the replacement recommendation includes a replacement schedule identifying replacement lighting products for each of the one or more lighting products identified by the user, based on payback computed using at least product cost of each of the replacement lighting products, the electricity rates of the energy provider, the number of hours each of the one or more lighting products is in use during a specified period of time, and cost saving estimates generated from the energy usage indicators for the replacement lighting products.

2. The system of claim 1 further comprising a procurement platform that includes:
a transactional system to process requests from the efficiency application to purchase or rent replacement lighting products selected by the user;
a payment system to process payment information from the user collected through the efficiency application; and
a product acquisition system to submit requests to one or more fulfillment centers to gather the replacement lighting products selected by the user.

3. The system of claim 1, wherein allowing the user to enter, select, or validate identifying information regarding an energy provider using the first graphical user interface includes requesting the user enter a zip code, requesting the user verify an auto-populated identification of a geographical location of the user generated using location based services, or generated using IP address geolocation and, in response to receiving the zip code or verification from the user, retrieving the energy provider or presenting a list of possible energy providers from which the user can select the energy provider.

4. The system of claim 1, wherein the room selection guide recommends different colors of light depending on the room selected by the user.

5. The system of claim 1, wherein the electricity rates of the energy provider are tiered based on monthly usage amounts and the user provides current bill amounts or other usage data via the one or more graphical user interfaces.

6. The system of claim 1, wherein the efficiency platform computes an individual lighting product savings based on the electricity rates of the energy provider and the energy usage indicators for each of the replacement lighting products

7. The system of claim 1, wherein the instructions corresponding to the efficiency application also generate a graphical representation that equates the cost saving estimates with a solar power system.

8. A computer-implemented method for operating an efficiency platform capable of generating customized energy plans, the computer-implemented method comprising:
receiving, from an efficiency application running on a computing device via a communications network, one or more indications of current lighting products in use by a user;
retrieving, from a database, an expected energy usage for each of the current lighting products in use by the user;
analyzing, using a processor, energy rates of a utility providing energy to the user,
wherein analyzing the energy rates of the utility includes identifying pricing tiers; and
generating, using the processor, a customized energy plan identifying one or more replacement lighting products,
wherein the customized energy plan is based, at least in part, on the expected energy usage of the current lighting products, features of the one or more replacement lighting products, and the pricing tiers of the utility.

9. The computer-implemented method of claim 8, wherein the customized energy plan also includes an evaluation of the environmental impact resulting from replacement of the current lighting products in use by the user with the one or more replacement lighting products.

10. The computer-implemented method of claim 8, further comprising:
receiving, from the efficiency application running on the computing device, a request to purchase at least some of the one or more replacement lighting products; and
submitting a procurement request to have the one or more replacement lighting products shipped directly to the user.

11. The computer-implemented method of claim 8, wherein each of the current lighting products in use by a user are associated with an identified room selected by the user via a room selection guide displayed on the computing device and the computer-implemented method further comprises:
receiving, from the efficiency application running on the computing device, a request to purchase at least some of the one or more replacement lighting products; and
submitting a procurement request to have the one or more replacement lighting products delivered directly to the user in a shipment,
wherein the procurement request includes a grouping of lights selected by the user within the room selection guide for each of the one or more replacement lighting products to allow the one or more replacement lighting products to be identified by the group of lights entered.

12. The computer-implemented method of claim 8, wherein the efficiency application allows the user to enter identifying information regarding the utility by requesting a zip code from the user or that the user validate an auto-populated location generated using location based services or generated using IP address geolocation and, in response to receiving the zip code or validation of the auto-populated location from the user, retrieving the energy provider or presenting a list of possible energy providers from which the user can select the energy provider.

13. The computer-implemented method of claim 8, wherein the efficiency platform generates cost saving estimates based in part on the energy rates of the utility and one or more replacement lighting products.

14. The computer-implemented method of claim 8, wherein each of the current lighting products in use by a user are associated with an identified room selected by the user via a room selection guide displayed on the computing device.

15. The computer implemented method of claim 8, wherein the one or more indications of current lighting products in use by the user include a photograph or a video stored in a memory on the computing device.

16. A system comprising:
a product database have stored thereon a plurality entries identifying information about lighting products,
wherein the information about each of the lighting products includes an energy usage indicator; and
an efficiency platform running on one or more servers and connected to multiple computing devices each running an efficiency application, wherein the efficiency application running on each of the computing devices is configured to collect lighting product information currently in use by a user via one or more graphical user interfaces and develop a replacement recommendation by identifying more efficient alternatives for each of the lighting products currently in use by the user.

17. The system of claim 16, wherein the one or more graphical user interfaces include:
a graphical user interface that allows the user to enter identifying information regarding an energy provider;
a graphical user interface that presents a room selection guide; and
a graphical user interface that, in response to a selection of a room from the room selection guide, presents a product selection guide allowing the user to select one or more lighting products that are currently in use in the room and requests the user enter the number of hours each of the one or more lighting products is in use during a specified period of time;

18. The system of claim 17, wherein the replacement recommendation is also based on the number of hours each of the one or more lighting products is in use during a specified time period.

19. The system of claim 16 further comprising a means for processing requests from the each of the efficiency applications to purchase or rent at least some of the replacement lighting products and a means for submitting requests to one or more fulfillment centers to gather the replacement lighting products selected by the user.

20. The system of claim 19, wherein the product selection guide presents recommended lighting products with different colors based on the room selected by the user.
